(19) United States
(12) Patent Application Publication
(10) Pub. No.: US 2016/0367433 A1
(43) Pub. Date: Dec. 22, 2016

(54) METHODS OF SUBCUTANEOUS TISSUE MANIPULATION

(71) Applicant: Active Release Techniques, Inc., Colorado Springs, CO (US)

(72) Inventor: Michael Leahy, Colorado Springs, CO (US)

(21) Appl. No.: 15/191,451

(22) Filed: Jun. 23, 2016

Related U.S. Application Data
(60) Provisional application No. 62/184,774, filed on Jun. 25, 2015.

(51) Int. Cl. A61H 23/06; A61H 99/00

(52) U.S. Cl. CPC A61H 23/06; A61H 99/00; A61H 2201/5007

(57) ABSTRACT

Methods of tissue manipulation are provided. Aspects of the methods include non-surgical methods for manipulating one or more tissues, such as human tissues. In some versions, the tissues are subcutaneous and the methods include differentiating at least a first tissue and a second tissue. Embodiments of the methods include inducing relative motion between a first tissue and a second tissue by, for example, applying pressure to one or more of the tissues and/or by inducing movement of at least a portion of a subject's body which is operatively connected to a tissue. The disclosed subject matter finds use in a variety of different applications, including alleviating symptoms of overuse conditions.

### CROSS-REFERENCE TO RELATED APPLICATIONS

This application claims the benefit under 35 USC 119(e) of co-pending U.S. Provisional Patent Application No. 62/184,774, filed Jun. 25, 2015, the disclosure of which is hereby incorporated by reference in its entirety.

### INTRODUCTION

There are a variety of different types of tissue in the human body. The four basic tissue types found in a human include connective tissue, muscle tissue, epithelial tissue, and nervous tissue. Some of these tissues are soft tissues. Soft tissues are tissues which are not bone and which connect, support, or surround other structures, e.g., organs, of a human body. Soft tissues may be subcutaneous and may include, for example, tendons, fascia, ligaments, skin, fibrous tissues, fat, synovial membranes, muscles, nerves, and blood vessels.

Humans can experience injuries to tissues, including soft tissues, as a result of a wide range of activities. For example, tissue injuries can be a result of sudden trauma resulting from a blow to the body. Tissue injuries can also result from repeated overuse, such as in ongoing athletic activities. In such a case, small amounts of body stress accumulate steadily over time and result in an injury. Tissue injuries may include strains, sprains, contusions, bursitis, tendonitis and stress injuries. These injuries can involve, for example, damage to ligaments, muscles and tendons and can have debilitating effects including swelling, bruising, pain and loss of function.

A diverse range of treatments exist for tissue injuries. Such treatments include surgical and non-surgical approaches. In many instances, the type of treatment selected depends on the severity and type of the injury. Various treatments include the administration of pain relievers and/or ice, compression, rest, or elevation. Procedures may also be applied to move the injured tissue portions in a manner that facilitates healthy function of the tissue portions, such as back into their normal position or to immobilize the injured tissue portions. Such procedures may be performed in a manner that alleviates one or more symptoms of the injury or otherwise encourages normal function of tissues.

### SUMMARY

Methods of tissue manipulation are provided. Aspects of the methods include non-surgical methods for manipulating one or more tissues, such as human tissues. In some versions, the tissues are subcutaneous and the methods include differentiating at least a first tissue and a second tissue. Embodiments of the methods include inducing relative motion between a first tissue and a second tissue by, for example, applying pressure to one or more of the tissues and/or by inducing movement of at least a portion of a subject's body which is operatively connected to a tissue. The disclosed subject matter finds use in a variety of different applications, including alleviating symptoms of overuse conditions.

According to various embodiments, the subject disclosure includes methods of non-surgical human tissue manipulation. Such methods include differentiating a first tissue of the subject and a second tissue of the subject, wherein the first tissue and the second tissue are each a subcutaneous tissue. The subject methods may also include inducing relative motion between the first tissue and the second tissue, wherein inducing the relative motion comprises restricting motion of the first tissue and causing the second tissue to move with respect to the first tissue. In various aspects, inducing relative motion between a first tissue and a second tissue includes applying pressure to the second tissue via a second contact area to thereby move the second tissue with respect to the first tissue. Also, in some versions, inducing relative motion between the first tissue and the second tissue increases freedom of movement between the first tissue and the second tissue.

In various embodiments, the first tissue and the second tissue are adjacent to one another. Also, in some versions, restricting motion of the first tissue includes applying pressure, e.g., tactilely applying pressure, to the first tissue. Where desired, the pressure is applied to the first tissue via a first contact area. Applying pressure to an aspect may also be referred to herein as taking tension on an aspect.

In some embodiments, restricting motion of the first tissue includes maintaining at least a portion of the subject's body in a position. Also, in some instances, causing the second tissue to move with respect to the first tissue includes inducing movement of at least a portion of the subject's body while the motion of the first tissue is restricted. According to various embodiments, inducing movement of at least a portion of the subject's body includes exerting an external force, such as tactilely exerting an external force, thereon.

Where appropriate, inducing movement of at least a portion of the subject's body includes instructing the subject to move the portion of the subject's body. In some aspects of the methods, the portion of the subject's body is operatively connected to the second tissue. Also, in some aspects, the portion of the subject's body is the subject's head or includes an appendage, e.g., an arm or leg, of the subject.

The methods, in some versions, may further include treating the subject for a tissue ailment, wherein the ailment includes a muscle overuse condition. Also, in some aspects, the methods include alleviating one or more symptoms of a tissue ailment. Such ailments may be conditions of one or more tissues, such as soft tissues, such as muscles, tendons, ligaments, fascia, or nerves. In some aspects, the ailments include carpal tunnel syndrome, shin splints, sciatica, plantar fasciitis, tennis elbow, or any combinations thereof. Symptoms of the ailments, according to various aspects, may include back pain, shoulder pain, knee pain, head pain, neck pain, elbow pain, wrist pain, ankle pain, or any combinations thereof.

According to various embodiments of the subject methods, a first tissue includes muscle tissue and a second tissue includes muscle tissue. Also, differentiating a first tissue of a subject and a second tissue of the subject, in some versions, includes palpating the subject. In some versions, the methods include diagnosing one or more tissue ailments in a subject by, for example, assessing functional movement of one or more portions of the subject's body. Furthermore, according to various embodiments, the methods include arranging at least a portion of the subject's body in an initial tissue manipulation position.

The methods of non-surgical human tissue manipulation according to the subject disclosure include methods of differentiating a first tissue of the subject and a second tissue of the subject, wherein the first tissue and the second tissue are each a subcutaneous tissue. The methods also may include inducing relative motion between the first tissue and the second tissue. Inducing relative motion between the first tissue and the second tissue may in turn include moving the first tissue a first distance by applying pressure to the first tissue via a first contact area and moving the second tissue a second distance, and wherein inducing relative motion between the first tissue and the second tissue includes increasing freedom of movement between the first tissue and the second tissue. In some versions of the methods, the second distance is longer than the first distance. Also, where appropriate, the first distance is in a first direction and the second distance is in a second direction which is opposite the first direction. In addition, in various embodiments, the first distance is in a first direction and the second distance is in the first direction.

In some versions of the methods, moving the second tissue a second distance includes applying pressure to the second tissue via a second contact area to thereby move the second tissue with respect to the first tissue. Also, in some instances, moving the first tissue a first distance and moving the second tissue a second distance includes inducing movement of at least a portion of the subject's body while pressure is applied to the first tissue.

Where appropriate, the methods include inducing movement of at least a portion of the subject's body by exerting an external force thereon. Inducing movement of at least a portion of the subject's body may also include instructing the subject to move the first portion of the subject's body. Also, embodiments of the methods include arranging at least a portion of the subject's body in an initial tissue manipulation position.

The subject disclosure, in some versions, includes methods of non-surgical human tissue manipulation by differentiating a first tissue, e.g., a tissue including muscle tissue, of the subject and a second tissue e.g., a tissue including muscle tissue, of the subject, wherein the first tissue and the second tissue are each a subcutaneous tissue. Such methods may also include inducing relative motion between the first tissue and the second tissue. Inducing relative motion between the first tissue and the second tissue may include applying pressure to the first tissue via a first contact area and applying pressure to the second tissue via a second contact area while moving the first tissue a first distance by inducing movement of at least a first portion of the subject's body which is operatively connected to the first tissue, and moving the second tissue a second distance by inducing movement of at least a second portion of the subject's body which is operatively connected to the second tissue. In some aspects, the second distance is longer than the first distance. Also, in some versions, the first distance is in a first direction and the second distance is in a second direction which is opposite the first direction. In addition, in some versions, the first distance is in a first direction and the second distance is in the first direction.

Inducing movement of at least the first portion of the subject's body, where appropriate, may include exerting an external force thereon. It may also include instructing the subject to move the first portion of the subject's body. Also, inducing movement of at least the second portion of the subject's body may include exerting an external force thereon. It may also include instructing the subject to move the second portion of the subject's body. Such methods may also include arranging at least a portion of the subject's body in an initial tissue manipulation position and/or increasing freedom of movement between the first tissue and the second tissue.

In various aspects, the subject methods include applying pressure to a first tissue to substantially prevent movement of the first tissue; and inducing movement of at least a portion of a body of a subject e.g., a portion of the subject's body which is operatively connected to the second tissue, e.g., at least a portion of one or more of an arm, leg, hand, finger, foot, toe, or head of a subject. Inducing such movement may include inducing movement of a second tissue with respect the first tissue, wherein the first tissue and the second tissue are each a subcutaneous tissue, and wherein the first tissue is adjacent to the second tissue within the body of the subject. Inducing such movement may also include exerting an external force on the portion of the body of the subject or instructing the subject to move the portion of the body of the subject. In some aspects, inducing movement of a second tissue with respect the first tissue comprises causing the second tissue to slide along the first tissue.

The methods described herein, also include alleviating one or more symptoms of one or more overuse conditions and/or increasing freedom of movement between a first tissue and a second tissue. The methods may also include diagnosing the subject with the one or more conditions, such as overuse conditions. Where appropriate, they also include differentiating a first tissue of a subject and a second tissue of the subject by palpating the subject. The subject methods also may include arranging at least a portion of the subject's body in an initial tissue manipulation position.

In embodiments of the methods, pressure is applied to a first tissue via a first contact area and/or a location of the first contact area is determined based on the diagnosis of the one or more overuse conditions. Such conditions may include, for example, carpal tunnel syndrome, shin splints, sciatica, plantar fasciitis, and/or tennis elbow. Also, one or more symptoms of the overuse conditions may include back pain, shoulder pain, knee pain, head pain, neck pain, elbow pain, wrist pain, and/or ankle pain.

### BRIEF DESCRIPTION OF THE FIGURES

FIGS. 1A and 1B are diagrams representing a method of non-surgical tissue manipulation according to embodiments of the present disclosure. FIGS. 1A and 1B specifically illustrate restricting motion of a tissue and causing another tissue to move with respect to the first tissue.

FIGS. 2A-C are diagrams providing cross-sectional views representing a method of tissue manipulation according to embodiments of the present disclosure.

FIGS. 3A and 3B are diagrams representing aspects of the subject methods. More specifically, FIG. 3A provides a partial cross-sectional view of a body portion and FIG. 3B provides symptom pattern images.

FIGS. 4A-D provide diagrams representing a method of non-surgical tissue manipulation according to embodiments of the present disclosure.

FIG. 5. is a diagram representing a method of non-surgical tissue manipulation according to embodiments of the present disclosure.

FIG. 6. is a diagram representing a method of non-surgical tissue manipulation according to embodiments of the present disclosure.

FIG. 7. is a diagram representing a method of non-surgical tissue manipulation according to embodiments of the present disclosure.

FIG. 8. is a diagram representing a method of non-surgical tissue manipulation according to embodiments of the present disclosure.

FIG. 9. is a diagram representing a method of non-surgical tissue manipulation according to embodiments of the present disclosure.

FIG. 10 provides a schematic a diagram of a cumulative injury cycle.

FIGS. 11A, 11B, and FIGS. 11C-11E are diagrams representing aspects of the subject methods. More specifically, FIG. 11A provides a partial cross-sectional view of a body portion, FIG. 11B provides a symptom pattern image, and FIGS. 11C-11E illustrate steps of tissue manipulation according to embodiments of the subject disclosure.

FIGS. 12A, 12B, and FIGS. 12C-12D are diagrams representing aspects of the subject methods. More specifically, FIG. 12A provides a partial cross-sectional view of a body portion, FIG. 12B provides symptom pattern images, and FIGS. 12C-12D illustrate steps of tissue manipulation according to embodiments of the subject disclosure.

FIGS. 13A, 13B, and FIGS. 13C-13E are diagrams representing aspects of the subject methods. More specifically, FIG. 13A provides a partial cross-sectional view of a body portion, FIG. 13B provides a symptom pattern image, and FIGS. 13C-13E illustrate steps of tissue manipulation according to embodiments of the subject disclosure.

FIG. 14 provides a schematic diagram of a computer system according to various embodiments of the subject disclosure.

### DETAILED DESCRIPTION

Methods of tissue manipulation are provided. Aspects of the methods include non-surgical methods for manipulating one or more tissues, such as human tissues. In some versions, the tissues are subcutaneous and the methods include differentiating at least a first tissue and a second tissue. Embodiments of the methods include inducing relative motion between a first tissue and a second tissue by, for example, applying pressure to one or more of the tissues and/or by inducing movement of at least a portion of a subject's body which is operatively connected to a tissue. The disclosed subject matter finds use in a variety of different applications, including alleviating symptoms of overuse conditions.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges may be presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed. To the extent such publications may set out definitions of a term that conflict with the explicit or implicit definition of the present disclosure, the definition of the present disclosure controls.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. It is also noted that definitions provided in one section of this application may also apply to embodiments described in another section of the application even if a term is described as applying to an embodiment of a particular section. In addition, characteristics of embodiments provided in one section of this application may also apply to embodiments described in another section of the application, even if a characteristic is described as applying to one or more embodiments of a particular section.

Additionally, certain embodiments of disclosed methods and/or devices can be represented by drawings which may be included in this application. Embodiments of the methods and their specific spatial characteristics and/or abilities include those shown or substantially shown in the drawings or which are reasonably inferable from the drawings. Such characteristics include, for example, one or more (e.g., one, two, three, four, five, six, seven, eight, nine, or ten, etc.) of: symmetries about a plane (e.g., a cross-sectional plane) or axis (e.g., an axis of symmetry), edges, peripheries, surfaces, specific orientations (e.g., proximal; distal), and/or numbers (e.g., three surfaces; four surfaces), and/or movements(s) with respect to any of such aspects, or any combinations thereof. Such spatial characteristics also include, for example, the lack (e.g., specific absence of) one or more (e.g., one, two, three, four, five, six, seven, eight, nine, or ten, etc.) of: symmetries about a plane (e.g., a cross-sectional plane) or axis (e.g., an axis of symmetry), edges, peripheries, surfaces, specific orientations (e.g., proximal), and/or numbers (e.g., three surfaces), or any combinations thereof.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### Methods

A variety of tissue manipulation methods are described herein. In some aspects, the methods are non-surgical methods for manipulating one or more tissues of a subject, such as human tissues.

By “manipulate” and “manipulation”, as used herein, is meant to move or control, such as to control position. Manipulation can be achieved manually, for example, by exerting force, such as by using one's hand or hands to exert force, to move something else, such as one or more tissues, such as one or more subcutaneous tissues. Manipulation can also be achieved, for example, in full or in part, by issuing a request or instructions to an organism and/or a machine, such as a machine having a controller, such as a computer.

The subject methods, in some embodiments, also include adjusting one or more tissues. As used herein, “adjusting” refers to changing the position, such as by moving, one or more aspects, such as one or more tissues. Adjusting can be achieved manually, for example, by using one's hand or hands to move something else, such as one or more tissues, such as one or more subcutaneous tissues. Adjusting may include re-positioning one or more aspects and may be temporary and/or permanent and/or for the entire duration of the life of a subject or for a portion of the duration thereof.

As is noted above, the subject methods may be non-surgical. Accordingly, in some versions of the disclosed methods, the methods are not a surgical procedure and/or are not associated with, such as performed at the same time or at the same location, as a surgical procedure. As used herein, the phrase “surgical procedure” refers to a procedure, e.g., a medical procedure, involving at least one incision in the body of a subject and/or performed using one or more instruments, e.g., surgical instruments. A surgical procedure may be carried out through a body cavity and/or through the skin of a subject. Also, in some embodiments, the subject methods are non-invasive. In other words, the methods, in some aspects, do not involve entry into the body of a subject by cutting or by inserting one or more instruments, such as cutting through the skin and/or inserting one or more instruments through an opening therein. In some embodiments, the methods are administered to a subject exclusively via a skin surface, such as an exterior skin surface of a subject and/or do not involve inserting any aspect into the body of a subject.

Also, the terms “tissue”, or “tissues” as used herein, refer to one or more aggregates of cells in a subject (e.g., a living organism, such as a mammal, such as a human) that have a similar function and structure, or to a plurality of different types of such aggregates. Tissue may include, for example, organ tissue, muscle tissue, e.g., skeletal muscle, connective tissue, nervous tissue and/or epithelial tissue. One or more tissues which are functionally grouped together may form an organ. Tissues may also be one or more soft tissues. “Soft tissue”, as used herein, refers to tissue that connects, supports, or surrounds other structures, e.g., organs, of a subject body and which is not bone. Soft tissues may be subcutaneous and may include connective tissue, such as tendons, fascia, ligaments, skin, fibrous tissues, fat and/or synovial membranes, or any combinations thereof, as well as tissues other than connective tissues, including muscles, nerves, and/or blood vessels, or any combinations thereof.

In some versions, one or more tissues are subcutaneous tissues. By “subcutaneous tissues”, as used herein, is meant tissues which are located under the skin of a subject. In other words, subcutaneous tissues are subdermal tissues located, e.g., naturally located in a normal healthy human, on the interior side of the interior surface of the skin, e.g., skin tissues, of a subject, where skin has an exterior surface on the exterior surface of a subject's body, and an interior surface opposite the exterior surface. Subcutaneous tissues, in some versions, are located under the epidermis and/or the dermis of a subject. Subcutaneous tissues according to the subject embodiments include, for example, one or more tissues of: muscle, e.g., skeletal muscle, tendons, ligaments, fascia, synovial membranes, nerves, bone, organ tissue, connective tissue, adipose tissue, vascular tissue, such as arteries and/or veins, or any combinations thereof. Also, as used herein, the terms “under” and “below, in reference to skin are used to describe one or more attributes on the interior side of the interior surface of the skin, e.g., skin tissues, of a subject. Likewise, the terms “over” and “above”, in reference to skin are used to describe one or more attributes on the exterior side of the exterior surface of the skin, e.g., skin tissues, of a subject.

The term “subject” is used interchangeably herein with the term “patient”. In certain embodiments, a subject is a “mammal” or “mammalian”, where these terms are used broadly to describe organisms which are within the class mammalia, including the orders carnivore (e.g., dogs and cats), rodentia (e.g., mice, guinea pigs, and rats), and primates (e.g., humans, chimpanzees, and monkeys). In some embodiments, subjects are humans. The term “humans” may include human subjects of both genders and at any stage of development (e.g., fetal, neonates, infant, juvenile, adolescent, adult), where in certain embodiments the human subject is a juvenile, adolescent or adult. While the methods described herein may be applied to perform one or more procedure and/or treatment on a human subject, it is to be understood that the subject methods may also be carried-out to perform a procedure and/or treatment on other subjects (that is, in “non-human subjects”).

In some versions, the methods disclosed herein are performed by a provider, such as a treatment provider, and/or a professional, such as a medical professional, such as a medical practitioner. In some versions, a provider is an expert in treating subjects for conditions or ailments, such as those described herein.

Embodiments of the subject methods include differentiating one or more first tissues, e.g., subcutaneous tissues, of a subject from one or more second tissues, e.g., subcutaneous tissues, of a subject. By “differentiating”, as used herein, is meant distinguishing one or more aspects, such as one or more tissues or properties of tissues, from one or more other aspects, such as one or more separate tissues or properties of separate tissues. Differentiating may include recognizing one or more attributes of a first aspect, such as a tissue, which are different than one or more attributes of a second aspect, such as a tissue. Differentiating may also include recognizing an aspect, such as an anatomical space, such as a space between tissues, or a tissue that separates a first aspect and a second aspect or is anatomically positioned, such as anatomically positioned in a normal healthy human, with respect to the first aspect and/or the second aspect. In addition, differentiating may include identifying one or more aspects, such as one or more tissues, and/or one or more other aspects, such as one or more separate tissues and/or anatomical features. Differentiating, according to the subject embodiments, can include recognizing one or more anatomical structure, such as one or more tissue, e.g., one or more subcutaneous tissue.

Differentiating may be performed visually and/or tactilely. For example, differentiating tissues, such as subcutaneous tissues, may be achieved by palpating a subject, such as palpating using one or more hands, or a portion thereof, such as one or more fingers. As used herein, “palpating” refers to examining one or more portions of a subject's body by touch. Palpating may include applying pressure, e.g., tactically applying pressure, to one or more portions of a subject's body one or more times. Palpating may also include rubbing and/or pressing on one or more portions of a subject's body. Differentiating may include recognizing a characteristic, such as a feeling and/or appearance, of one or more tissues, such as subcutaneous tissues and/or one or more portions of a subject's skin above subcutaneous tissues. Such characteristics may include, for example, position, size, movability, e.g., pliability and/or slidability, texture, e.g., smoothness, and/or roughness, or other characteristics, or any combinations thereof.

Differentiating, such as tactilely differentiating, may be performed via the skin of a subject, such as through the skin of a subject. In other words, differentiating may include making tactile contact with one or more portions of the skin of a subject, such as an exterior surface and/or epidermis thereof. Accordingly, differentiating may include sensing, such as tactilely and/or visually sensing, one or more characteristics of tissues, such as subcutaneous tissues, through the skin. As such, differentiating may include tacitly interacting with, e.g., touching, the skin of a subject or a portion thereof, such as the exterior surface and/or epidermis, and/or by viewing the skin of a subject or a portion thereof, such as the exterior surface and/or epidermis.

In some versions of the methods, differentiating may also include deciding which portion of the skin of a subject or a portion thereof, such as the exterior surface and/or epidermis should be examined, e.g., tactilely and/or visually examined, such as by palpation, to obtain information necessary to recognize a characteristic, such as a feeling and/or appearance, of one or more tissues, such as subcutaneous tissues. In other words, differentiating may also include making a determination of which area of subject's body to evaluate for performing differentiation. Differentiating may also be performed, at least in part, by recognizing one or more symptoms affecting an area of a subject's body, such as pain and/or swelling and/or an inability of a body part to move as it would in a normal healthy human.

In some versions, differentiating may also include using one or more aspects, such as tools and/or instruments, to recognize a characteristic, such as a physical abnormality, of one or more tissues, such as subcutaneous tissues, of a subject. Such aspects, e.g., tools and/or instruments, might include scanning tools such as tools for visually analyzing the interior of a subject's body. Such tools and/or instruments may include one or more of an ultrasound machine, X-ray machine, computed tomography (CT) or computerized axial tomography (CAT) scanner, magnetic resonance imaging (MRI) machine, a computer system, or any combinations thereof. Tools and/or instruments of the subject embodiments may also include one or more device including a sensor, such as an electronic sensor, for sensing one or more characteristics of tissues, such as subcutaneous tissues, wherein the one or more sensor may be applied for sensing on the exterior of a subject's skin surface. In some embodiments, such sensors may be configured to detect one or more physical characteristics, such as size, shape, temperature, and/or movement of one or more tissues, such as skin. In some embodiments, such a device may include a display for displaying the one or more sensed characteristics to a user.

Tools for use in differentiating, in some versions, also include one or more visual aids, such as one or more forms of media, such as a book, e.g., a printed book or an e-book, a slide-show, a video, e.g., a digital video, or a computer program for providing media on a display of an electronic device, e.g., a phone and/or computer, or any combinations thereof. Any of such media tools for differentiating may be used for example, prior to, or during differentiation to assist in differentiating one or more aspects, such as tissues.

Media tools, according to some aspects, may include information, such as pictures and/or text, describing and/or illustrating locations of tissues, such as subcutaneous tissues, with respect to general anatomical features, e.g., a finger, or a tissue thereof, and/or with respect to other tissues. Such tools may also include information, such as pictures and/or text, describing and/or illustrating any of the methods described herein. The tools may also include information including instruction for gathering information tactilely to differentiate between tissues. Such information, for example, includes recommended areas of a subject's body for performing differentiation based on one or more symptoms. Such information, for example, may also include recommended tactile placement, such as hand placement of a provider on a subject. Recommended tactile placement, such as hand placement, may include recommended placement for performing differentiation and/or recommended placement, such as hand placement, for performing or inducing tissue movement, according to any of the methods described herein. Information provided by media tools may also illustrate one or more steps of movement, such as body and/or tissue movement according to the methods described herein. The subject methods, in some aspects, also include diagnosing a subject, by applying one or more of the described tools, such as a printed publication, e.g., a book, and/or video and/or computer program, for differentiation.

In some versions, the disclosed methods include differentiating a first tissue of the subject and a second tissue of the subject. The first tissue and the second tissue may be the same type of tissue or different types of tissue. For example, the first or second tissue can each be a connective tissue, e.g., tendon, fascia, ligament, fibrous tissue, fat and/or synovial membrane. The first or second tissue can also each be or include a muscle, nerve, and/or blood vessel tissue. The first or second tissue can each be a soft tissue. The first tissue and the second tissue, in some embodiments, are also both subcutaneous tissues. For example, in some embodiments, the first tissue can be a first muscle and the second tissue can be a second muscle, such as an adjacent muscle. In some embodiments, the first tissue can be a muscle and the second tissue can be a tendon attached thereto and attaching the muscle to a bone.

Embodiments of the methods include inducing relative motion or movement between a first tissue and a second tissue. “Inducing”, as used herein, refers to bringing something about and includes causing something, such as movement, to occur. As used herein, the phrases “relative motion” and “relative movement” refer to motion or movement of one aspect in reference to another aspect. In other words, the methods include causing a first tissue a first tissue to move with respect to a second tissue. A first muscle that is moved relative to a second muscle may be moved a distance while the second muscle does not move. Accordingly, relative motion between a first aspect and a second aspect may include: a first aspect moving while a second aspect does not move; a second aspect moving while a first aspect does not move; a first aspect moving in a first direction and a second aspect moving in a second direction which is different than the first direction; and a first aspect moving a first distance in a first direction, and a second aspect moving a second distance in the first direction, wherein the first distance and the second distance are not the same; or any combination thereof. In some embodiments, the methods include causing a tissue, e.g., a second tissue, to move with respect to a tissue, e.g., a first tissue.

In some versions of the subject methods, the methods include inducing relative motion between a first aspect, such as a tissue, or a portion thereof, and a second aspect, such as a tissue, or a portion thereof, while simultaneously moving the first and second aspect, such as by inducing movement of at least a portion of a subject's body, relative to a third aspect, such as a center of mass of a subject's body, and/or a point on the ground upon which the subject is standing, and/or a point on an object upon which a subject is lying or sitting. Inducing movement of at least a portion of a subject's body is described in further detail below and may be performed by exerting an external force thereon, such as tactilely and/or manually. Inducing movement of at least a portion of a subject's body may also be performed by instructing or asking a subject to move the portion of the subject's body or a portion of the subject's body operatively connected thereto. Inducing movement of at least a portion of a subject's body, in some versions, includes instructing a subject to use one portion of the subject's body to move another portion of the subject's body. Inducing movement of at least a portion of a subject's body, also, in some aspects may include a first step of inducing a portion of a subject's body to move and one or more subsequent steps of doing the same. For example, inducing movement of at least a portion of a subject's body, in some aspects, may include a first step of causing the portion of the subject's body to move partially within the normal range of motion of that portion of the subject's body, and one or more subsequent steps, such as a second step of inducing a portion of a subject's body to move, such as by causing the portion of the subject's body to move the remaining amount within the normal range of motion of that portion of the subject's body.

In various embodiments of the methods, inducing relative motion between a first aspect, such as a first tissue, or a portion thereof, and a second aspect, such as a second tissue, or a portion thereof, includes causing the first aspect to move 1 m or less, such as 75 cm or less, such as 50 cm or less, such as 25 cm or less, such as 20 cm or less, such as 19 cm or less, such as 18 cm or less, such as 17 cm or less, such as 16 cm or less, such as 15 cm or less, such as 14 cm or less, such as 13 cm or less, such as 12 cm or less, such as 11 cm or less, such as 10 cm or less, such as 9 cm or less, such as 8 cm or less, such as 7 cm or less, such as 6 cm or less, such as 5 cm or less, such as 4 cm or less, such as 3 cm or less, such as 2.5 cm or less, such as 2 cm or less, such as 1.5 cm or less, such as 1 cm or less, such as 8 mm or less, such as 6 mm or less, such as 5 mm or less, such as 4 mm or less, such as 2 mm or less, such as 1 mm or less, with respect to the second aspect, and/or another aspect, as described herein. In such embodiments, the first and/or the second tissue, such as the first tissue but not the second tissue, or the second tissue but not the first tissue, may be moved any of such distances. In some embodiments, causing the first aspect to move with respect to the second aspect, and/or another aspect, as described herein, includes moving the second aspect and not the first aspect, or the first aspect, and not the second aspect, or moving the first and second aspect, such as moving the first and second aspects in a single direction or in opposite directions.

Also, in some embodiments of the methods, inducing relative motion between a first aspect, such as a first tissue, or a portion thereof, and a second aspect, such as a second tissue, or a portion thereof, includes causing the first aspect to move 1 m or more, such as 75 cm or more, such as 50 cm or more, such as 25 cm or more, such as 20 cm or more, such as 19 cm or more, such as 18 cm or more, such as 17 cm or more, such as 16 cm or more, such as 15 cm or more, such as 14 cm or more, such as 13 cm or more, such as 12 cm or more, such as 11 cm or more, such as 10 cm or more, such as 9 cm or more, such as 8 cm or more, such as 7 cm or more, such as 6 cm or more, such as 5 cm or more, such as 4 cm or more, such as 3 cm or more, such as 2.5 cm or more, such as 2 cm or more, such as 1.5 cm or more, such as 1 cm or more, such as 8 mm or more, such as 6 mm or more, such as 5 mm or more, such as 4 mm or more, such as 2 mm or more, such as 1 mm or more, with respect to the second aspect, and/or another aspect, as described herein. In such embodiments, the first and/or the second tissue, such as the first tissue but not the second tissue, or the second tissue but not the first tissue, may be moved any of such distances.

Furthermore, in various embodiments of the methods, inducing relative motion between a first aspect, such as a first tissue, or a portion thereof, and a second aspect, such as a second tissue, or a portion thereof, includes causing the first aspect, or a portion thereof, to move a distance in an range of, for example: 0.1 mm to 1 m; 1 mm to 1 m; 5 mm to 1 m; 1 cm to 1 m; 1 mm to 75 cm; 1 mm to 50 cm; 1 mm to 40 cm; 1 mm to 30 cm; 1 mm to 25 cm; 1 mm to 20 cm; 1 mm to 19 cm; 1 mm to 18 cm; 1 mm to 17 cm; 1 mm to 16 cm; 1 mm to 15 cm; 1 mm to 14 cm; 1 mm to 13 cm; 1 mm to 12 cm; 1 mm to 11 cm; 1 mm to 10 cm; 1 mm to 9 cm; 1 mm to 8 cm; 1 mm to 7 cm; 1 mm to 6 cm; 1 mm to 5 cm; 1 mm to 4 cm; 1 mm to 3 cm; 1 mm to 2 cm; 1 mm to 1 cm; 1 mm to 9 mm; 1 mm to 8 mm; 1 mm to 7 mm; 1 mm to 6 mm; 1 mm to 5 mm; 1 mm to 4 mm; 1 mm to 3 mm; 1 mm to 2 mm, 1 cm to 50 cm; 1 cm to 40 cm; 1 cm to 30 cm; 1 cm to 25 cm; 1 cm to 20 cm; 1 cm to 15 cm; 1 cm to 14 cm; 1 cm to 13 cm; 1 cm to 12 cm; 1 cm to 11 cm; 1 cm to 10 cm; 1 cm to 9 cm; 1 cm to 8 cm; 1 cm to 7 cm; 1 cm to 6 cm; 1 cm to 5 cm; 1 cm to 4 cm; 1 cm to 3 cm; 1 cm to 2 cm; 1 cm to 9 mm; 1 mm to 8 mm; 1 mm to 7 mm; 1 mm to 6 mm; 1 mm to 5 mm; 1 mm to 4 mm; 1 mm to 3 mm; or 1 mm to 2 mm, with respect to the second aspect, or a portion thereof, and/or another aspect, as described herein.

In some aspects of the methods, the methods include moving a first tissue and/or a second tissue in one or more natural tissue movement directions. By “natural tissue movement direction” as used herein, is meant a direction of tissue movement in which a tissue would move in a normal healthy human. As such, one or more natural tissue movement directions may include a first natural tissue movement direction which a tissue would move when one or muscles are flexed, and a second natural tissue movement direction opposite the first direction in which a tissue would move when the one or more muscles are relaxed. In some versions, the methods include moving one or more tissues, e.g., a first and/or second tissue, in a direction transverse, e.g., perpendicular, to one or more natural tissue movement directions. In some versions, the methods include moving, e.g., moving one or more times, a first tissue and/or a second tissue a first distance in a first natural tissue movement direction, and then the first distance in a second natural tissue movement direction opposite the first direction, for example, to return the first tissue and/or second tissue to an original position. In some aspects, the methods include applying pressure and/or moving a first tissue and/or a second tissue a distance in a direction or to a position which is superior, inferior, proximal, distal, abducted, adducted, rotated, radial, supinated, and/or extended, with respect to the other tissue, e.g., first and/or second tissue, and/or another tissue, e.g., a proximate tissue, and/or a portion of a body of a subject.

According to some embodiments of the subject methods, inducing the relative motion includes restricting motion of one or more tissue, e.g., a first tissue or a second tissue, or a portion of a first or second tissue. Restricting motion of a tissue may include slowing and/or stopping movement of a tissue, or a portion thereof. In some versions of the methods, restricting motion includes inhibiting an aspect, such as a tissue, from moving, e.g., moving from a first position to a second position, such as moving in its naturally allowed full range of movement, which is the range of movement that such a tissue would have in a normal, i.e., average, healthy human. Also, in some versions, the methods include substantially preventing movement of one or more aspects, such as a tissue, for example, by causing the one or more aspects to substantially remain in a position.

Restricting motion may include causing a tissue, or a portion, e.g., a majority portion, thereof, to remain in a position or to substantially remain in a position. As used herein, “substantially” means to a great or significant extent, such as almost fully or almost entirely. As such, as used herein, an aspect that “substantially remains in a position” refers to an aspect, such as a tissue or a portion thereof, which essentially remains in the position but may move a small amount. Accordingly, an aspect, such as a tissue, or a portion thereof, that substantially remains in a position may move or have a portion move a small amount, such as an amount that is not detectable without one or more movement detection instruments, such as a microscopic amount, or an amount that cannot be sensed, e.g., seen or felt, by a human, such as a normal healthy human, or an amount that would prevent the disclosed methods from functioning as disclosed herein. Also, an aspect, such as a tissue, or a portion thereof, that substantially remains in a position may move or have a portion move a small amount, such as an amount which is 20% or less; such as 15% or less; such as 10% or less; such as 5% or less; such as 1% or less; such as 0.5% or less, of that aspect's, e.g., tissue's, normal range of motion, e.g., the range of motion of the same type tissue and performing the same function in a normal healthy human. Accordingly, an aspect, such as a tissue, or a portion thereof, that substantially remains in a position may move 10 cm or less, such as 5 com or less, such as 3 cm or less, such as 1 cm or less, such as 0.1 cm or less, such as 0.01 cm or less, such as 0.001 cm or less. Furthermore, substantially reducing motion of a tissue may include fully restricting motion of a first part of a tissue, such as a majority part, such as the majority part of a muscle, while another part, such as a portion of the muscle or a tendon at an end of a muscle, moves, such as moves a small amount.

Restricting motion, in some aspects, may include trapping a tissue against another aspect, such as a tissue, such as a soft tissue and/or bone tissue, including, for example, one or more bones. As such, in some versions, the methods may include applying pressure to a first tissue so that the tissue is pressed against a second tissue and the first tissue's motion is thereby restricted, for example, when a portion of a subject's body to which the first tissue is operatively connected is moved. In some versions, trapping a first tissue against another aspect, such as a second tissue, may include applying a force to the first tissue in a direction which is transverse, such as perpendicular to a surface of the second tissue, such as a surface which contacts the first tissue. Also, in some versions, trapping a first tissue against a second tissue may increase friction between the tissues when one of the tissues is moved and/or attempted to be moved.

In addition, motion of an aspect, e.g., tissue, or a portion thereof, may be restricted and/or induced with respect to another aspect, e.g., tissue, of the body of a subject and/or with respect to the center of mass of the body of a subject. Also, motion of an aspect, e.g., tissue, or a portion thereof, may be restricted and/or induced with respect to another aspect, e.g., tissue, of the body of a subject while the aspect, e.g., tissue, or a portion thereof, is moved with respect to another aspect, such as the center of mass of the body of a subject, and/or or the ground surface upon which the subject is standing, and/or an object upon which a subject is sitting or lying or a portion of such an object.

In some embodiments, restricting motion of one or more aspect, such as one or more tissue, such as a first tissue and/or a second tissue, includes maintaining at least a portion of a subject's body in a position. Maintaining an aspect, such as a body of a subject, or a portion thereof, such as an appendage, in a position includes causing the subject's body or portion thereof, e.g., a head, torso, or appendage such as an arm and/or leg, or a portion thereof, such as a foot and/or hand, or a portion thereof, such as one or more fingers, to not move or not move substantially. Maintaining a subject's body, or portion thereof, in a position may include instructing the subject to hold the subject's body and/or portion thereof in a position. Maintaining a subject's body, or portion thereof, in a position, in some aspects, includes holding, such as tactilely and/or manually holding, a subject's body or portion thereof in a position and without substantial movement. For example, maintaining at least a portion of a subject's body in a position might include maintaining a subject's torso in a position without substantial movement while another portion of the subject's body is moved, such as a head, or appendage such as an arm and/or leg, or a portion thereof, such as a foot and/or hand, or a portion thereof, such as one or more fingers.

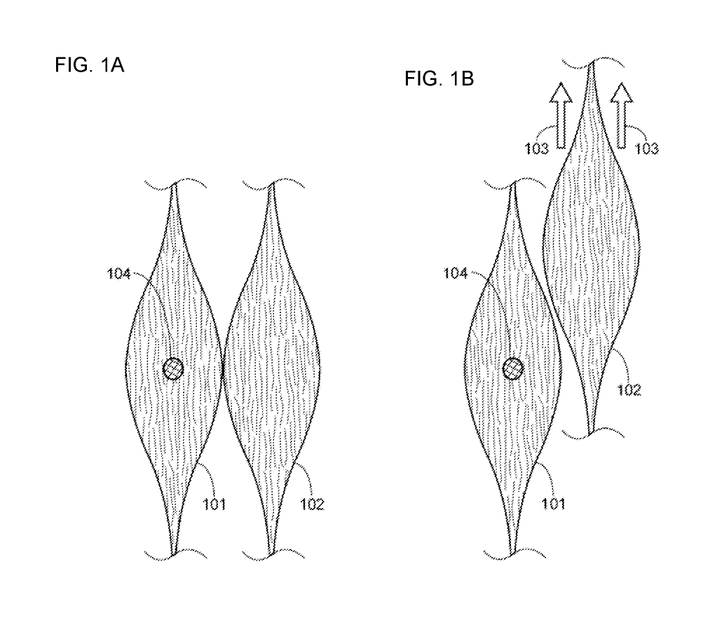

FIGS. 1A and 1B provide diagrams representing a method of non-surgical tissue manipulation according to embodiments of the present disclosure. As noted above, aspects of the methods include differentiating tissues of a subject, such as a first tissue 101 of the subject, such a subcutaneous soft tissue, and a second tissue 102 of the subject, such as a subcutaneous soft tissue. The methods also include inducing relative motion between a first tissue 101 and a second tissue 102. According to some embodiments, inducing relative motion includes restricting motion of the first tissue 101 by, for example, applying pressure to the first tissue 101 via a contact area 104. The contact area 104 shown in FIG. 1 is depicted on the surface of a subcutaneous tissue however pressure may be applied to a contact area on a subcutaneous tissue via a contact area on a skin surface above and/or proximate the subcutaneous contact area. In other aspects, which are not shown, motion of the first tissue may be restricted by maintaining at least a portion of the subject's body in a position. Continued application of pressure via contact area 104 prevents the first tissue 101 from moving or from substantially moving. Inducing relative motion also, in some aspects, includes causing the second tissue 102 to move 103, with respect to the first tissue 101, as is shown in FIG. 1B. In some versions, the methods include returning the second tissue 102 to its initial position, such as the position shown in FIG. 1A. Returning the second tissue 102 to its initial position may include causing it to move an equal distance in an opposite direction and repeating the entire process a plurality, such as two, three, five, or ten or more times.

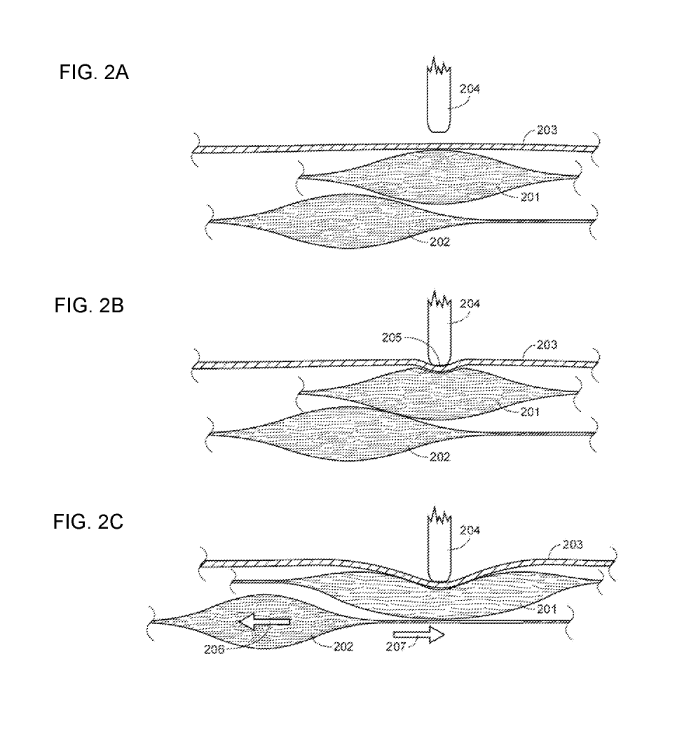

Another embodiment of the subject methods is provided by FIGS. 2A-C. FIG. 2A provides a cross-sectional illustration of a first tissue 201 and a second tissue 202 in a first position, which is their position in a normal resting human, e.g., an initial tissue manipulation position. The first tissue 201 and second tissue 202 are both subcutaneous tissues and as such, are located below the skin 203 of a subject. FIG. 2B illustrates application of pressure to the first tissue 201. In FIG. 2B, pressure applicator 204 exerts a force, e.g., an external force, on first tissue 201 via the skin 203. As shown, pressure is applied by pressure applicator 204, e.g., an instrument or a portion of a body of a provider, such as one or more appendage, or a portion of one or more appendage, such one or two arms or portions thereof, such one or two hands or portions thereof, such as ten or less fingers, or portions thereof, such as nine, eight, seven, six, five, four, three, two, or one finger. Pressure is also applied via contact area 205. Continued application of pressure via contact area 205 prevents the first tissue 201 from moving or from substantially moving. Also, as is depicted in FIG. 2C, while pressure is applied by the pressure applicator 204, the second tissue 202 may be moved, such as by inducing motion of one or more portions of a subject's body. The second tissue 202 may be moved one or more times, in a direction 206 away from the contact area 205 and/or the first tissue 201. The second tissue 202 may be moved one or more times, in a direction 207 toward from the contact area 205 and/or the first tissue 201. In some versions, the methods include returning the second tissue 202 to its initial position, such as by causing it to more an equal distance in an opposite direction, e.g., 207, that it was initially moved and repeating the process a plurality, such as two, three, five, or ten or more times.

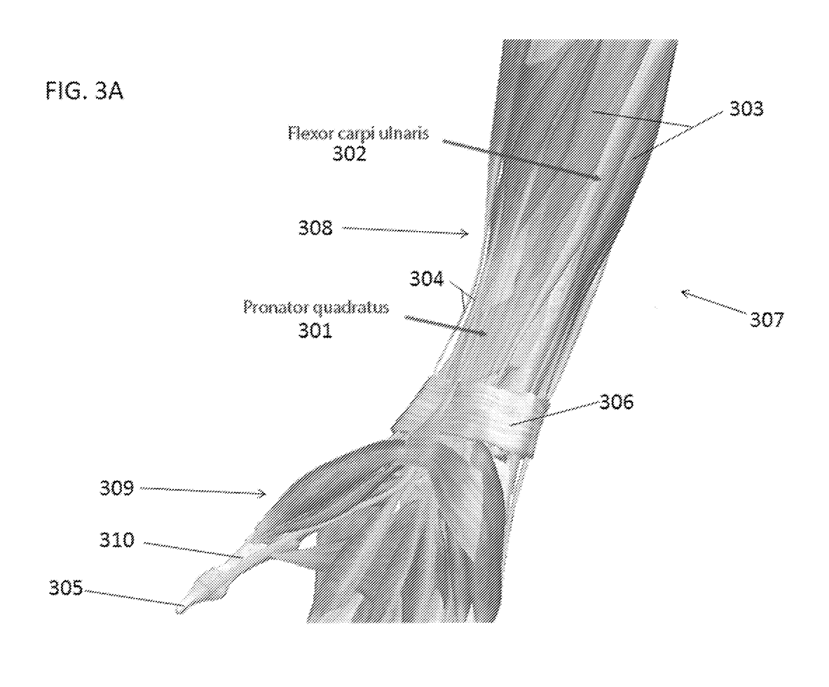

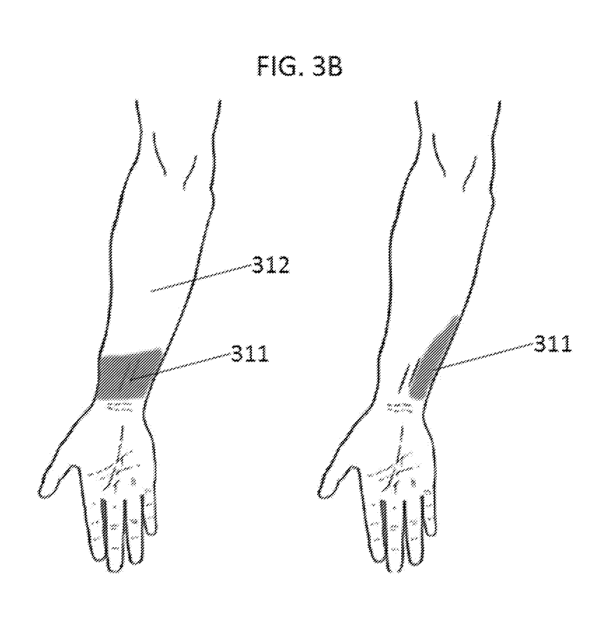

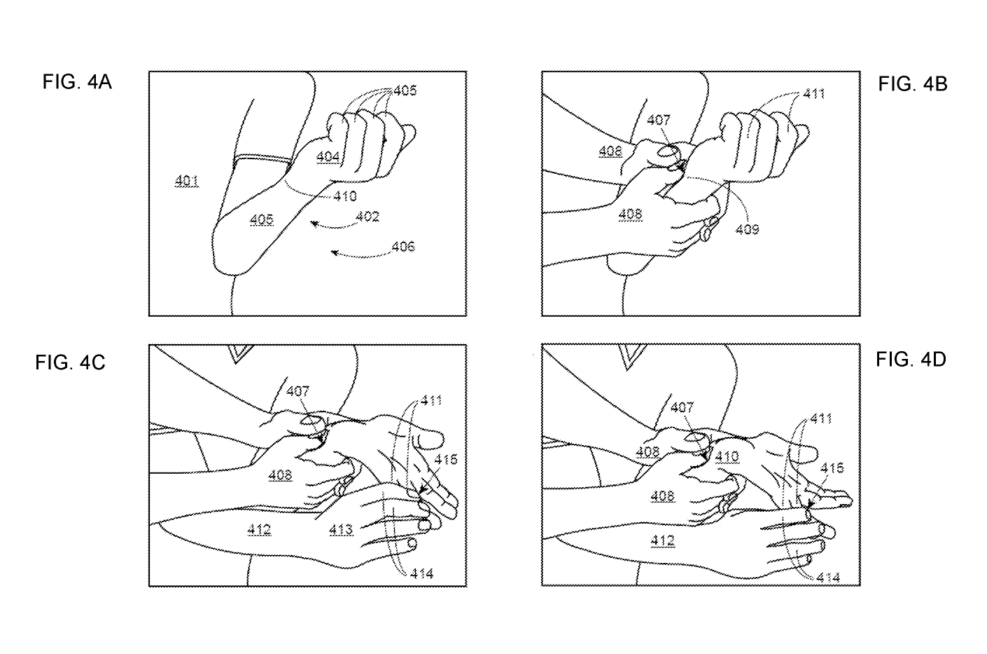

Also, as discussed above and illustrated in FIG. 3A, aspects of the methods include differentiating tissues of a subject, such as a first tissue 301 of the subject, such a subcutaneous soft tissue, e.g., a pronator quadratus of a subject, and a second tissue 302 of the subject, such as a subcutaneous soft tissue, e.g., a flexor carpi ulnaris of a subject. In some embodiments, the methods include differentiating the first tissue 301 and/or a second tissue 302 from surrounding tissues, such as muscle tissue 303, tendon 304, bone tissue 305, and/or connective tissue 306, or any combinations thereof. In some versions, the first tissue 301 and/or second tissue 302 are tissues of an appendage 307. As is shown in FIG. 3A, the appendage 307 may be an arm 308 which includes a hand 109, which includes one or more finger 310. An appropriate method of non-surgical tissue manipulation including the described differentiation and/or the steps illustrated in FIGS. 4A-D may be selected to treat symptoms appearing within or proximate symptom pattern areas 311 on a human arm 312 shown in the symptom pattern images depicted in FIG. 3B.

FIGS. 4A-D provide diagrams representing a method of non-surgical tissue manipulation according to embodiments of the present disclosure. As is illustrated, for example by FIG. 4A, embodiments of the subject disclosure include arranging at least a portion of the subject's body, such as a torso 401 and/or an appendage 402, or a portion thereof, such as an arm 403 and/or a hand 404 and/or one or more fingers 405, in an initial tissue manipulation position 406. In some versions, an initial tissue manipulation position may a position in which the subject maintains the subject's wrist 410 in a neutral and/or pronated and/or flexed, e.g., slightly flexed, position. As noted above, the methods, according to some embodiments, also include differentiating a first tissue of the subject, such as a subcutaneous soft tissue within the arm 403 of a subject, e.g., a pronator quadratus, and a second tissue of the subject, such as a subcutaneous soft tissue within the arm 403 of a subject, e.g., a flexor carpi ulnaris.

Embodiments of the subject disclosure also include inducing relative motion between a first tissue, such as a subcutaneous soft tissue e.g., a pronator quadratus, and a second tissue, such as a subcutaneous soft tissue, e.g., a flexor carpi ulnaris. In some aspects, and as is illustrated in FIG. 4B, inducing the relative motion includes restricting motion of the first tissue by, for example, applying pressure to the first tissue, such as a subcutaneous soft tissue e.g., a pronator quadratus, via first contact area 409. As is shown in FIG. 4B, in some versions, pressure is applied tactilely to a portion of a subject's arm 403, using one or more hands 408. Pressure may also be applied to the first tissue in a direction 407 which is inward and/or substantially perpendicular with a surface of the subject's skin, e.g., a surface of the subject's skin at the contact area 409.

Also, as is shown, for example, by FIG. 4C, embodiments of the subject disclosure include inducing relative motion between the first tissue and the second tissue by causing a second tissue, such as a subcutaneous soft tissue, e.g., a flexor carpi ulnaris, to move with respect to a first tissue, such as a subcutaneous soft tissue e.g., a pronator quadratus. In some versions, a second tissue, such as a subcutaneous soft tissue, e.g., a flexor carpi ulnaris, is operatively connected to at least a portion of the subject's body, e.g., one or more fingers 411, such as a ring finger and/or a pinky finger, which are induced to move. As such, motion, such as extension, of the at least a portion of the subject's body, e.g., one or more fingers 411, causes the second tissue, such as a subcutaneous soft tissue, e.g., a flexor carpi ulnaris, to move.

In some versions, the methods include inducing movement of at least a portion of the subject's body e.g., one or more fingers 411, while motion of the first tissue is restricted or substantially restricted. As is shown in FIGS. 4C and 4D, in some versions, pressure is continuously applied, such as tactilely, with one or two hands 408, to a portion of a subject's arm 403, such as to the first tissue in a direction 407 at the contact area 409, to for example, restrict motion or substantially restrict motion of the first tissue, while movement of at least a portion of the subject's body, e.g., one or more fingers 411, is induced. Applying pressure, in some aspects, includes putting tension, e.g., a radial tension, on a first tissue, such as a subcutaneous soft tissue e.g., a pronator quadratus. Applying pressure, in some aspects, also may include putting a tension, e.g., a distal and/or proximal tension, on a second tissue, such as a subcutaneous soft tissue, e.g., a flexor carpi ulnaris.

In some versions of the provided methods, inducing movement of at least a portion of the subject's body e.g., one or more fingers 411, including exerting, e.g., tactilely exerting, an external force thereon. In some versions, force is exerted in a direction 415 which may be transverse to and/or substantially perpendicular to a surface of the subject's skin to which the force is exerted. In some force is exerted in a direction 415 which may extend or contract the one or more portions, e.g., one or more fingers 411, of the subject's body.

Embodiments of the methods include inducing movement of at least a portion of the subject's body e.g., one or more fingers 411, to a first position, as shown in FIG. 4C, such as a first extended position, and/or a second position, as shown in FIG. 4D, such as a second extended position. Methods provided herein may include inducing movement of at least a portion of the subject's body, e.g., one or more fingers 411, by instructing the subject to move the portion of the subject's body. The methods also may include inducing movement of at least a portion of the subject's body e.g., one or more fingers 411, by instructing the subject to use another portion of the subject's body, such as an appendage thereof, such as an arm 412, and/or a hand 413, and/or one or more fingers 414 thereof, to move the portion of the subject's body, e.g., one or more fingers 411. In some versions of the methods, and as is shown in FIG. 4D, inducing movement of at least a portion of the subject's body may include moving a portion of a subject's body, e.g., a wrist 410, into supination, extension and/or deviation, e.g., radial deviation. While such action is taken, a first tissue of the subject, such as a subcutaneous soft tissue, e.g., a pronator quadratus, will be held and/or substantially maintained in a position while a second tissue of the subject, such as a subcutaneous soft tissue, e.g., a flexor carpi ulnaris, moves, such as moves distally and/or proximally. Embodiments of the methods which are not shown include inducing movement of at least a portion of the subject's body e.g., one or more fingers, an equal distance in an opposite direction as the portion of the subject's body is initially moved. Such aspects may include returning the portion of the subject's body to the initial tissue manipulation position.

Also, as described above, the disclosed embodiments include methods wherein restricting motion of an aspect, e.g., tissue, or substantially restricting motion of an aspect includes applying pressure, e.g., a steady pressure, to the aspect, e.g., tissue. Applying pressure may include exerting force on something. Such a force can be an external force, that is, a force which is exerted on an aspect from a location external to the aspect, such as by another aspect which is different than the first aspect. Applying pressure may include depressing, and/or inwardly moving, one or more aspect, such as one or more tissues including skin and/or one or more, e.g., first and/or second, subcutaneous tissues. Applying pressure may include moving, e.g., inwardly moving, e.g., depressing, one or more aspect, such as one or more tissues including skin 5 cm or less, such as 3 cm or less, such as 2 cm or less, such as 1.5 cm or less, such as 1 cm or less, such as 9 mm or less, such as 8 mm or less, such as 7 mm or less, such as 6 mm or less, such as 5 mm or less, such as 4 mm or less, such as 3 mm or less, such as 2 mm or less, such as 1 mm or less, or 5 cm or more, 3 cm or more, 2 cm or more, 1.5 cm or more, 1 cm or more, 9 mm or more, 8 mm or more, 7 mm or more, 6 mm or more, 5 mm or more, 4 mm or more, 3 mm or more, 2 mm or more, or 1 mm or more, or a distance in a range of 1 mm to 5 cm; 1 mm to 4 cm; 1 mm to 3 cm; 1 mm to 2 cm; 1 mm to 1 cm; 1 mm to 9 mm; 1 mm to 8 mm; 1 mm to 7 mm; 1 mm to 6 mm; 1 mm to 5 mm; 1 mm to 4 mm; 1 mm to 3 mm; 1 mm to 2 mm, 1 cm to 50 cm; 1 cm to 40 cm; 1 cm to 30 cm; 1 cm to 25 cm; 1 cm to 20 cm; 1 cm to 15 cm; 1 cm to 14 cm; 1 cm to 13 cm; 1 cm to 12 cm; 1 cm to 11 cm; 1 cm to 10 cm; 1 cm to 9 cm; 1 cm to 8 cm; 1 cm to 7 cm; 1 cm to 6 cm; 1 cm to 5 cm; 1 cm to 4 cm; 1 cm to 3 cm; 1 cm to 2 cm; 1 cm to 9 mm; 1 mm to 8 mm; 1 mm to 7 mm; 1 mm to 6 mm; 1 mm to 5 mm; 1 mm to 4 mm; 1 mm to 3 mm; or 1 mm to 2 mm. Applying pressure, such as applying pressure to one or more tissue, such as a first and/or second tissue, can also, in some versions, include applying pressure to the one or more tissue through the skin of a subject by applying pressure to the exterior surface of the skin of the subject. Embodiments of the methods include applying pressure to a first tissue to substantially prevent movement of the first tissue, before and/or simultaneously with, and/or after inducing movement of at least a portion of a body of a subject.

In some versions, pressure is applied tactilely. In other words, pressure may be applied by touching, such as by a provider touching a subject. Applying pressure tactilely may include contacting a skin surface of a subject with a skin surface, e.g., an exterior skin surface, of a provider. As used herein, “provider” refers to a human performing one or more of the methods or aspects thereof, such as performing the methods on a subject. Applying pressure tactilely may include touching a subject with one or more appendage, or portion thereof, such as one or more hand, or portion thereof, such as one or more finger, such as ten, nine, eight, seven, six, five, four, three, two, or one finger. Applying pressure may include exerting force on a subject by pressing one or more appendage, or portion thereof, such as one or more hand, or portion thereof, such as one or more finger, such as ten, nine, eight, seven, six, five, four, three, two, or one finger against a subject or a portion thereof, such as one or more contact area.

Applying pressure, in various aspects of the methods, includes applying a pressure in an amount which is normally exertable, e.g., tactilely exertable and/or manually exertable, by a human, such a normal or average adult human. Applying pressure may be done manually, or in other words, solely by a provider's physical ability and without using one or more instruments or other aspects to apply pressure. Applying a pressure, may be in an amount achievable for example, by a human making physical contact with an aspect and pushing and/or pulling the aspect or portions thereof tactilely, such as with one or more of its hands and/or fingers. Applying a pressure, may be in an amount which does not provide lasting physical damage, e.g., a tissue injury, such as a bruise and/or tear, to the subject to which the pressure is applied. Embodiments of the methods also include applying a pressure, such as applying a pressure to a skin surface of a subject in an amount which restricts or substantially restricts motion of one or more tissue below the skin, such as a first subcutaneous tissue, and/or a second subcutaneous tissue when, for example, the subject attempts to move the first and/or second tissue within its normal range of motion or when one or more operatively connected tissues, e.g., tissues of a leg, arm or finger, are moved within in their normal range of motion.

Applying a pressure and/or exerting a force, such as an external force, as described further below, may be in an amount of, for example, 0.1 kg/cm2 to 50 kg/cm2, 0.1 kg/cm2 to 10 kg/cm2, 0.2 kg/cm2 to 5 kg/cm2, or 0.3 kg/cm2 to 3 kg/cm2. Pressure may be applied in a direction which is perpendicular or substantially perpendicular to a surface of a subject's skin at a point or location at which the pressure is applied, such as a contact area. As used herein, “contact area” refers to a position on the body of a subject and/or on a tissue, such as a position of a surface, e.g., exterior surface, of the skin of the subject to which pressure is applied to, for example, restrict motion of one or more tissues, e.g., subcutaneous tissues, and/or move one or more tissues e.g., subcutaneous tissues. A contact area includes the position on the body of a subject with which the aspect applying pressure, such as one or more portions of a body of a provider, such as an appendage, such as one or more hands, such as one or more fingers, makes contact, e.g., physical contact. In some aspects, contact areas are areas where a provider touches a subject. In some versions of the methods, there are more than one contact areas, such as two, three, four, five, or ten or more, contact areas. Contact areas, in some aspects, may have an area, e.g., an area on the surface of the skin of a subject, of between 1 mm2 and 10 cm2, such as between 5 mm2 and 5 cm2, such as between 5 mm2 and 1 cm2 or between 1 cm2 and 5 cm2, each range inclusive. By “inclusive”, as used herein in association with ranges means that the range includes both of the provided endpoints. All ranges provided herein are inclusive, regardless of whether the term is provided in association with a particular range or unless indicated otherwise. Contact areas, in some aspects, may have an area of 1 mm2 or larger, such as 5 mm2 or larger, such as 1 cm2 or larger, such as 2 cm2 or larger, such as 5 cm2 or larger, such as 10 cm2 or larger. Contact areas, in some aspects, also may have an area of 1 mm2 or smaller, 5 mm2 or smaller, 1 cm2 or smaller, 2 cm2 or smaller, 5 cm2 or smaller, 10 cm2 or smaller.

Furthermore, in some versions of the methods, one or more contact areas may be above, e.g., above on a skin surface, such as directly above, a tissue to which pressure is applied via the contact area. Also, in some versions, one or more contact areas are not directly above, e.g., above on a skin surface, a tissue to which pressure is applied. In some instances, a contact area may be adjacent to a tissue to which pressure is applied via the contact area. For example, in some versions, pressure may be applied to a tissue via a contact area in a direction which is from the side or parallel with the surface of a subject's skin at the position above the tissue.

According to various embodiments of the methods, pressure is applied to one or more tissue, e.g., a first and/or second tissue, via one or more contact area, e.g., a first and/or second contact area, each of which are at a location on a subject's body. In some aspects, a location of one or more contact area, e.g., a first and/or second contact area, on a subject's body is determined based on a diagnosis of one or more ailments, such as tissue ailments, such as one or more muscle overuse conditions. Diagnosing a subject is described in greater detail below.

Two or more contact areas, such as a first contact area, and a second contact area, may have a distance between them, such as a distance on a surface of the skin of a subject of, for example: 1 m or less, such as 75 cm or less, such as 50 cm or less, such as 25 cm or less, such as 20 cm or less, such as 19 cm or less, such as 18 cm or less, such as 17 cm or less, such as 16 cm or less, such as 15 cm or less, such as 14 cm or less, such as 13 cm or less, such as 12 cm or less, such as 11 cm or less, such as 10 cm or less, such as 9 cm or less, such as 8 cm or less, such as 7 cm or less, such as 6 cm or less, such as 5 cm or less, such as 4 cm or less, such as 3 cm or less, such as 2.5 cm or less, such as 2 cm or less, such as 1.5 cm or less, such as 1 cm or less, such as 8 mm or less, such as 6 mm or less, such as 5 mm or less, such as 4 mm or less, such as 2 mm or less, such as 1 mm or less, or 1 m or more, such as 75 cm or more, such as 50 cm or more, such as 25 cm or more, such as 20 cm or more, such as 19 cm or more, such as 18 cm or more, such as 17 cm or more, such as 16 cm or more, such as 15 cm or more, such as 14 cm or more, such as 13 cm or more, such as 12 cm or more, such as 11 cm or more, such as 10 cm or more, such as 9 cm or more, such as 8 cm or more, such as 7 cm or more, such as 6 cm or more, such as 5 cm or more, such as 4 cm or more, such as 3 cm or more, such as 2.5 cm or more, such as 2 cm or more, such as 1.5 cm or more, such as 1 cm or more, such as 8 mm or more, such as 6 mm or more, such as 5 mm or more, such as 4 mm or more, such as 2 mm or more, such as 1 mm or more.

Two or more contact areas, such as a first contact area, and a second contact area, may have a distance between them, such as a distance on a surface of the skin of a subject ranging from, for example: 0.1 mm to 1 m; 1 mm to 1 m; 5 mm to 1 m; 1 cm to 1 m; 1 mm to 75 cm; 1 mm to 50 cm; 1 mm to 40 cm; 1 mm to 30 cm; 1 mm to 25 cm; 1 mm to 20 cm; 1 mm to 19 cm; 1 mm to 18 cm; 1 mm to 17 cm; 1 mm to 16 cm; 1 mm to 15 cm; 1 mm to 14 cm; 1 mm to 13 cm; 1 mm to 12 cm; 1 mm to 11 cm; 1 mm to 10 cm; 1 mm to 9 cm; 1 mm to 8 cm; 1 mm to 7 cm; 1 mm to 6 cm; 1 mm to 5 cm; 1 mm to 4 cm; 1 mm to 3 cm; 1 mm to 2 cm; 1 mm to 1 cm; 1 mm to 9 mm; 1 mm to 8 mm; 1 mm to 7 mm; 1 mm to 6 mm; 1 mm to 5 mm; 1 mm to 4 mm; 1 mm to 3 mm; 1 mm to 2 mm, 1 cm to 50 cm; 1 cm to 40 cm; 1 cm to 30 cm; 1 cm to 25 cm; 1 cm to 20 cm; 1 cm to 15 cm; 1 cm to 14 cm; 1 cm to 13 cm; 1 cm to 12 cm; 1 cm to 11 cm; 1 cm to 10 cm; 1 cm to 9 cm; 1 cm to 8 cm; 1 cm to 7 cm; 1 cm to 6 cm; 1 cm to 5 cm; 1 cm to 4 cm; 1 cm to 3 cm; 1 cm to 2 cm; 1 cm to 9 mm; 1 mm to 8 mm; 1 mm to 7 mm; 1 mm to 6 mm; 1 mm to 5 mm; 1 mm to 4 mm; 1 mm to 3 mm; or 1 mm to 2 mm.

Embodiments of the methods also include applying pressure in a direction which is distal and/or proximal and/or substantially distal and/or proximal. As used herein, the term “distal” refers to a direction oriented toward a subject, or a portion thereof, such as an appendage, torso, and/or head, or a portion thereof, or a center of mass of the subject or a portion thereof in reference to a portion to which pressure is being applied, such as a contact area. Accordingly, “distal” may refer to a direction oriented away from a person administering pressure to a subject, or a portion of the administering person, such as an appendage or a portion thereof, e.g., a hand or a portion thereof, e.g., a finger, torso, and/or head, or a portion thereof with which pressure is being applied. Also, as used herein, the term “proximal” refers to a direction oriented away from a subject, or a portion thereof, such as an appendage, torso, and/or head, or a portion thereof and/or a portion of a subject to which pressure is being applied, such as a contact area. Accordingly, “proximal” may refer to a direction oriented toward a person administering pressure to a subject, or a portion of the administering person, such as an appendage or a portion thereof, e.g., a hand or a portion thereof, e.g., a finger, torso, and/or head, or a portion thereof with which pressure is being applied. Also, in some versions of the methods, pressure may be applied in a direction which is inward and/or downward with respect to the skin of a subject at the point or location at which the pressure is being applied. Furthermore, applying pressure may include exerting a pressure in a first direction and then, or simultaneously with, one or more other directions, such as a second direction, such as a direction which is perpendicular or substantially perpendicular to the first direction. Embodiments of the methods also include applying pressure in a direction which is downward or substantially downward, or inward or substantially inward, with respect to a skin surface of a subject.

Pressure may also be applied, in some versions, in a direction which is latitudinal and/or longitudinal and/or substantially latitudinal and/or substantially longitudinal with respect to a tissue, such as a subcutaneous tissue. The term “longitudinal” as used herein refers to the characteristic of being associated with (e.g., placed or running along) a length (e.g., a straight or curved length) or lengthwise dimension. For example, in some versions, a tissue may have a length, a width and a height. In some aspects, the length is greater than the width and/or the height. In some aspects, a tissue is connected to one or more other tissues at a first end, and connected to one or more tissues at a second end, and the lengthwise dimension is defined by an axis running from the center of the first to the center of the second end of the tissue, for example, when the tissue and/or the portion of the body of the subject wherein the tissue is located, is in a resting state, such as when the subject is in a supine position. In some aspects, a longitudinal direction of a tissue is a direction that is parallel to the lengths of the fibers, such as organized fibers, of a tissue. For example, a longitudinal direction of a tissue may be a direction that is parallel to the average direction defined by the lengths of the fibers and/or cells of the tissue, such as the lengths of the fibers of the tissue which are located at a midpoint between a first and second end of a tissue, such as a tissue of a subject which is in a resting supine position.

Pressure may also be applied according to some aspects of the methods, in a direction which is perpendicular to a latitudinal and/or longitudinal direction with respect to a tissue, such as a subcutaneous tissue. By “latitudinal” as used herein, refers to a direction which is perpendicular, e.g., transverse, to a longitudinal direction. As such, a latitudinal direction may be perpendicular e.g., transverse, to lengths of fibers, such as organized fibers, of a tissue. For example, a latitudinal direction of a tissue may be a direction that is perpendicular to the average direction defined by the lengths of the fibers of the tissue, such as the lengths of the fibers of the tissue which are located at a midpoint between a first and second end of a tissue, such as a tissue of a subject which is in a resting supine position. Also, in some versions, pressure is applied to a tissue and/or a tissue is moved in a direction which is not perpendicular to the organized fibers of that tissue, such as the fibers at the location on the tissue where pressure is applied. Furthermore, in some aspects, pressure is not applied in a direction parallel to the organized fibers of that tissue, such as the fibers at the location on the tissue where pressure is applied. In various embodiments, an element providing pressure is not moved across a tissue in a direction perpendicular to the organized fibers of that tissue, such as the fibers at the location on the tissue where pressure is applied, while pressure is being applied.

Embodiments of the methods of the subject disclosure also include moving the second tissue with respect to the first tissue, such as a first tissue having restricted motion, by for example, applying pressure to the second tissue. In various embodiments of the methods, applying pressure includes moving a first aspect, such as a first tissue, or a portion thereof, and/or a second aspect, such as a second tissue, or a portion thereof, 1 m or less, such as 75 cm or less, such as 50 cm or less, such as 25 cm or less, such as 20 cm or less, such as 19 cm or less, such as 18 cm or less, such as 17 cm or less, such as 16 cm or less, such as 15 cm or less, such as 14 cm or less, such as 13 cm or less, such as 12 cm or less, such as 11 cm or less, such as 10 cm or less, such as 9 cm or less, such as 8 cm or less, such as 7 cm or less, such as 6 cm or less, such as 5 cm or less, such as 4 cm or less, such as 3 cm or less, such as 2.5 cm or less, such as 2 cm or less, such as 1.5 cm or less, such as 1 cm or less, such as 8 mm or less, such as 6 mm or less, such as 5 mm or less, such as 4 mm or less, such as 2 mm or less, such as 1 mm or less, 1 m or more, such as 75 cm or more, such as 50 cm or more, such as 25 cm or more, such as 20 cm or more, such as 19 cm or more, such as 18 cm or more, such as 17 cm or more, such as 16 cm or more, such as 15 cm or more, such as 14 cm or more, such as 13 cm or more, such as 12 cm or more, such as 11 cm or more, such as 10 cm or more, such as 9 cm or more, such as 8 cm or more, such as 7 cm or more, such as 6 cm or more, such as 5 cm or more, such as 4 cm or more, such as 3 cm or more, such as 2.5 cm or more, such as 2 cm or more, such as 1.5 cm or more, such as 1 cm or more, such as 8 mm or more, such as 6 mm or more, such as 5 mm or more, such as 4 mm or more, such as 2 mm or more, such as 1 mm or more.

Also, in some versions, applying pressure includes moving a first aspect, such as a first tissue, or a portion thereof, and/or a second aspect, such as a second tissue, or a portion thereof, a distance in an range of, for example: 0.1 mm to 1 m; 1 mm to 1 m; 5 mm to 1 m; 1 cm to 1 m; 1 mm to 75 cm; 1 mm to 50 cm; 1 mm to 40 cm; 1 mm to 30 cm; 1 mm to 25 cm; 1 mm to 20 cm; 1 mm to 19 cm; 1 mm to 18 cm; 1 mm to 17 cm; 1 mm to 16 cm; 1 mm to 15 cm; 1 mm to 14 cm; 1 mm to 13 cm; 1 mm to 12 cm; 1 mm to 11 cm; 1 mm to 10 cm; 1 mm to 9 cm; 1 mm to 8 cm; 1 mm to 7 cm; 1 mm to 6 cm; 1 mm to 5 cm; 1 mm to 4 cm; 1 mm to 3 cm; 1 mm to 2 cm; 1 mm to 1 cm; 1 mm to 9 mm; 1 mm to 8 mm; 1 mm to 7 mm; 1 mm to 6 mm; 1 mm to 5 mm; 1 mm to 4 mm; 1 mm to 3 mm; 1 mm to 2 mm, 1 cm to 50 cm; 1 cm to 40 cm; 1 cm to 30 cm; 1 cm to 25 cm; 1 cm to 20 cm; 1 cm to 15 cm; 1 cm to 14 cm; 1 cm to 13 cm; 1 cm to 12 cm; 1 cm to 11 cm; 1 cm to 10 cm; 1 cm to 9 cm; 1 cm to 8 cm; 1 cm to 7 cm; 1 cm to 6 cm; 1 cm to 5 cm; 1 cm to 4 cm; 1 cm to 3 cm; 1 cm to 2 cm; 1 cm to 9 mm; 1 mm to 8 mm; 1 mm to 7 mm; 1 mm to 6 mm; 1 mm to 5 mm; 1 mm to 4 mm; 1 mm to 3 mm; or 1 mm to 2 mm.

In various embodiments of the methods inducing relative motion between a first aspect, e.g., a first tissue, and a second aspect, e.g., a second tissue, includes applying pressure to the second tissue via a second contact area to thereby move the second tissue with respect to the first tissue. In such embodiments, the second aspect, such as the second tissue, may be moved any of the distances provided above with respect to the first aspect, such as the first tissue. Also, in some embodiments, the second aspect, such as the second tissue, may be moved with respect to the first tissue while the motion of the first tissue is restricted or substantially restricted. In addition, the second aspect, such as the second tissue, may be moved a distance in a direction away from and/or toward the first aspect. Also, the second aspect, such as the second tissue, may be moved, e.g., slid, a distance along the first tissue. Furthermore, the second aspect, such as the second tissue, may also be with respect to the first aspect such as the first tissue one or more times, such as two, three, four, five or more, ten or more, twenty or more or fifty or more times.

In various embodiments of the methods, inducing relative motion between a first aspect, e.g., a first tissue, and a second aspect, e.g., a second tissue, may include performing or inducing: abduction; adduction; flexion; extension; rotation, such as medial rotation and/or lateral rotation; supination; and/or pronation on one or more portions of a subject's body. Such portions of a subject's body may include one or more tissues and/or a head, or appendage such as an arm and/or leg, or a portion thereof, such as a foot and/or hand, or a portion thereof, such as one or more fingers. Inducing relative motion between a first aspect, e.g., a first tissue, and a second aspect, e.g., a second tissue, may be achieved by applying a steady pressure to a subject while a portion of the subject's body is moved, such as moved by the subject in response to instructions to do so.

According to aspects of the subject embodiments, inducing movement of at least a portion of a subject's body, e.g., an anatomical feature, may be performed by exerting a force, such as an external force, thereon. An external force may be exerted tactilely and/or manually. For example, inducing movement of a subject's arm may be performed by contacting the arm, e.g., grabbing the arm, retaining contact, e.g., holding the subject's arm, and moving the arm, e.g., rotating the arm, with respect to the subject's torso. The portion of a subject's body which may be moved might include one or more tissues, such as a plurality of tissues, such as soft tissue and/or bone tissue. The portion of a subject's body which may be moved can include, for example, a head or portion thereof, a torso or portion thereof, or an appendage or a portion thereof, e.g., a hand or a portion thereof, e.g., a finger.

Exerting an external force on an aspect, such as a portion of a subject's body, to induce movement of a least a portion of the subject's body includes exerting a force on an aspect from a location external to the aspect, such as by another aspect which is different than the first aspect. Exerting an external force on an aspect may also include any of the characteristics, such as amounts of force and/or pressure, directions of exertion, etc. as applying pressure to a subject's body, as applying such pressure is described above.

In some aspects, inducing movement of at least a portion of a subject's body, such as by exerting an external force thereon, may include causing or performing: abduction; adduction; flexion; extension; rotation, such as medial rotation and/or lateral rotation; supination; and/or pronation on one or more portions of a subject's body. Such portions of a subject's body may include one or more tissues and/or a head, or appendage such as an arm and/or leg, or a portion thereof, such as a foot and/or hand, or a portion thereof, such as one or more fingers.

Exerting an external force on a portion of a subject's body may include tactilely exerting the force and may include grasping and/or holding and/or applying pressure to one or more portions of the subject's body. Exerting an external force may include exerting force on a subject by pressing one or more appendage, or portion thereof, such as one or more force-applying instrument and/or hand, or portion thereof, such as one or more finger, such as ten, nine, eight, seven, six, five, four, three, two, or one finger against a subject or a portion thereof.

Exerting an external force, in various aspects of the methods, includes applying a pressure in an amount which is normally exertable, e.g., tactilely exertable and/or manually exertable, by a human, such a normal or average adult human. Exerting an external force may be done manually, or in other words, solely by a provider's physical ability and without using one or more instruments or other aspects to apply pressure. Exerting a force, may be in an amount achievable for example, by a human making physical contact with an aspect and pushing and/or pulling the aspect or portions thereof tactilely, such as with one or more of its hands and/or fingers. Exerting an external force may be in an amount which does not provide lasting physical damage, e.g., a tissue injury, such as a bruise and/or tear, to the subject to which the pressure is applied.

Embodiments of the methods also include exerting an external force to move a portion of a subject's body, e.g., a head, torso, and/or appendage, or a portion thereof, fully or partially within its normal range of motion. For example, an external force can be exerted to move one or more operatively connected tissues, e.g., tissues of a leg, arm or finger, within in their normal range of motion. Embodiments of the methods include exerting an external force to move a portion of a subject's body its full normal range of motion or a percentage thereof, such as 90% or less; 80% or less; 60% or less; 50% or less; 40% or less; 20% or less; such as 15% or less; such as 10% or less; such as 5% or less; such as 1% or less; such as 0.5% or less, of that aspect's, e.g., tissue's, normal range of motion.

Force, such as an external force, may be applied in a direction which is perpendicular or substantially perpendicular, e.g., transverse, to a surface of a subject's skin at one or more point or location, e.g., a first and second location, at which the force is applied, such as a force application area. One or more forces may also be applied in a longitudinal and/or lateral direction with respect to, for example, a tissue of a subject. Force may also be applied in one or more directions to rotate, slide, push, pull, lift, and/or lower one or more portions of a subject's body, with respect to, for example a center of mass of a subject. For example, force may be applied to rotate a portion of a subject's body about an axis of motion and/or within a plane. As such, the term “plane” as used herein refers to a flat surface that is infinitely large with zero thickness, unless a particular thickness is otherwise specified or can reasonably be inferred. Additionally, the term “longitudinal” as used herein refers to the characteristic of being associated with (e.g., placed or running along) a length (e.g., a straight or curved length) or lengthwise dimension. A lateral direction may be perpendicular to a longitudinal direction. Additionally, force, such as an external force, may be applied in any direction in which pressure may be applied, as described above.

A force, such as an external force, may be applied to move a portion of a subject's body, such as a head, torso, and/or appendage, or a portion thereof, such as one or more tissues of an appendage 1 m or less, such as 75 cm or less, such as 50 cm or less, such as 25 cm or less, such as 20 cm or less, such as 19 cm or less, such as 18 cm or less, such as 17 cm or less, such as 16 cm or less, such as 15 cm or less, such as 14 cm or less, such as 13 cm or less, such as 12 cm or less, such as 11 cm or less, such as 10 cm or less, such as 9 cm or less, such as 8 cm or less, such as 7 cm or less, such as 6 cm or less, such as 5 cm or less, such as 4 cm or less, such as 3 cm or less, such as 2.5 cm or less, such as 2 cm or less, such as 1.5 cm or less, such as 1 cm or less, such as 8 mm or less, such as 6 mm or less, such as 5 mm or less, such as 4 mm or less, such as 2 mm or less, such as 1 mm or less, 1 m or more, such as 75 cm or more, such as 50 cm or more, such as 25 cm or more, such as 20 cm or more, such as 19 cm or more, such as 18 cm or more, such as 17 cm or more, such as 16 cm or more, such as 15 cm or more, such as 14 cm or more, such as 13 cm or more, such as 12 cm or more, such as 11 cm or more, such as 10 cm or more, such as 9 cm or more, such as 8 cm or more, such as 7 cm or more, such as 6 cm or more, such as 5 cm or more, such as 4 cm or more, such as 3 cm or more, such as 2.5 cm or more, such as 2 cm or more, such as 1.5 cm or more, such as 1 cm or more, such as 8 mm or more, such as 6 mm or more, such as 5 mm or more, such as 4 mm or more, such as 2 mm or more, such as 1 mm or more.

Also, in some versions, force, such as an external force, may be applied to move a portion of a subject's body, such as a head, torso, and/or appendage, or a portion thereof, such as one or more tissues of an appendage a distance in an range of, for example: 0.1 mm to 1 m; 1 mm to 1 m; 5 mm to 1 m; 1 cm to 1 m; 1 mm to 75 cm; 1 mm to 50 cm; 1 mm to 40 cm; 1 mm to 30 cm; 1 mm to 25 cm; 1 mm to 20 cm; 1 mm to 19 cm; 1 mm to 18 cm; 1 mm to 17 cm; 1 mm to 16 cm; 1 mm to 15 cm; 1 mm to 14 cm; 1 mm to 13 cm; 1 mm to 12 cm; 1 mm to 11 cm; 1 mm to 10 cm; 1 mm to 9 cm; 1 mm to 8 cm; 1 mm to 7 cm; 1 mm to 6 cm; 1 mm to 5 cm; 1 mm to 4 cm; 1 mm to 3 cm; 1 mm to 2 cm; 1 mm to 1 cm; 1 mm to 9 mm; 1 mm to 8 mm; 1 mm to 7 mm; 1 mm to 6 mm; 1 mm to 5 mm; 1 mm to 4 mm; 1 mm to 3 mm; 1 mm to 2 mm, 1 cm to 50 cm; 1 cm to 40 cm; 1 cm to 30 cm; 1 cm to 25 cm; 1 cm to 20 cm; 1 cm to 15 cm; 1 cm to 14 cm; 1 cm to 13 cm; 1 cm to 12 cm; 1 cm to 11 cm; 1 cm to 10 cm; 1 cm to 9 cm; 1 cm to 8 cm; 1 cm to 7 cm; 1 cm to 6 cm; 1 cm to 5 cm; 1 cm to 4 cm; 1 cm to 3 cm; 1 cm to 2 cm; 1 cm to 9 mm; 1 mm to 8 mm; 1 mm to 7 mm; 1 mm to 6 mm; 1 mm to 5 mm; 1 mm to 4 mm; 1 mm to 3 mm; or 1 mm to 2 mm.

In various embodiments of the subject methods, inducing movement of at least a portion of a subject's body, may also be performed by instructing or asking a subject to move the portion of the subject's body or a portion of the subject's body operatively connected thereto. For example, inducing movement of a subject's head, arm, wrist, hand, finger, leg, ankle, and/or toe, may be performed by instructing the subject to move the subject's head, arm, wrist, hand, finger, leg, ankle, and/or toe. Instructing a subject to move a portion of the subject's body, in various aspects, includes requesting, such as verbally requesting, that the subject move or attempt to move a portion of the subject's body fully or partially within that portion's normal full range of motion. Instructing a subject to move a portion of the subject's body, in some versions of the methods includes requesting that the subject move, such as rotate, extend, compress, flex, and/or slide, or any combinations thereof, one or more portions of the subject's body. Instructing a subject to move a portion of the subject's body, in some versions of the methods, includes requesting that the subject move a portion of its body in a first movement, and then requesting that the subject move the portion of its body or another portion of its body, in one or more additional movements.

As used herein, the phrase “operatively connected”, means connected in a specific way that allows the disclosed methods to be carried out and/or devices to operate effectively in the manner described herein. For example, one aspect, such as a first tissue, which is operatively connected to a second aspect, such as a second tissue, may be fixedly connected to the second tissue, such as physically connected and/or connected such that when the first tissue moves, the second tissue moves, e.g., moves the same or substantially the same distance as the first tissue, because force, such as a pulling and/or pushing force, is exerted on the second tissue by the first tissue. In some aspects, one or more muscles are operatively connected to one or more tendons, which in turn, may be operatively connected to one or more bones. In some versions, one or more portion of a subject's body, e.g., a head, and/or an appendage, such as an arm, hand, finger, and/or leg, foot, toe, or a portion thereof, such a portion which is moved, is operatively connected to one or more tissue, such as a first and/or second tissue, such as a soft tissue, such as one or more muscle, tendon, ligament, and/or connective tissue. For example, moving an arm, and/or a portion thereof, which is operatively connected to a muscle, such as a pectoralis major muscle, of a subject may move the muscle, and/or a portion thereof.

Various embodiments of the methods also include a first aspect, such as a first tissue, and a second aspect, such as a second tissue, which are attached to one another. For example, a first tissue having a first and second end opposite the first end may be attached at its first and/or second end to a second tissue having a first and second end opposite the first end at the first and/or second end of the second tissue.

The methods, in some embodiments, include a first aspect, such as a first tissue, and a second aspect, such as a second tissue, which are adjacent to one another, such as adjacent to one another within the body of a subject. By “adjacent” as used herein is meant next to, such as close to, and/or sharing a border, point, and/or wall. For example, two adjacent aspects, such as tissues, may be within 5 cm or less, such as 1 cm or less, such as 5 mm or less, such as 1 mm or less, of one another within the body of a subject, such as a normal, healthy human. Also, one tissue adjacent to another tissue may be contacting the other tissue. One tissue adjacent to another tissue may be separated from that tissue by a layer, such as by a layer of connective tissue, such as only a layer of connective tissue, within the body of a subject. One tissue adjacent to another tissue may be attached to that tissue and/or may be oriented to move, e.g., slide, along that tissue when a subject's body, or a portion thereof, moves. For example, a first tissue adjacent to a second tissue may, in some aspects, be a first soft tissue, such as muscle or tendon or ligament or connective tissue, which is next to, e.g., contacting, a second soft tissue, such as muscle or tendon or ligament or connective tissue, within the body of a subject and may move, e.g., slide, therealong when the subject moves a portion of its body. A first tissue adjacent to a second tissue may also, in some aspects, be a first soft tissue, such as a muscle, which is next to a second soft tissue, such as a muscle, within the body of a subject and may move, e.g., slide, along one or more other, e.g., connective, tissues positioned between the first tissue and the second tissue when the subject moves a portion of its body. Accordingly, in some versions of the disclosed subject matter, a first tissue adjacent to a second tissue may be separated from one another by a third tissue, e.g., a connective tissue, such as only one other tissue, and/or a fourth tissue, within the body of a subject.

In various aspects of the methods, inducing movement of an aspect, e.g., a first and/or second tissue, with respect to another aspect, e.g., a first and/or second tissue, includes causing one of the aspects to slide along the other aspect. By “slide” is meant move an aspect along, e.g., move an aspect in a longitudinal direction, while maintaining contact with another other aspect or a third aspect, e.g., a connective tissue, separating the first and second aspect. Inducing movement of an aspect, in some versions, includes causing a second aspect, e.g., tissue, to slide along a first aspect, e.g., tissue, such as a stationary first aspect. Inducing movement of an aspect, also may include causing a first aspect, e.g., tissue, to slide along a second aspect, e.g., tissue, such as a stationary second aspect. Inducing movement of an aspect, also in some versions, includes causing a first aspect, e.g., tissue, to slide along a second aspect, e.g., tissue, and simultaneously causing a second aspect, e.g., tissue, to slide along a first aspect, e.g., tissue, such as a stationary first aspect.

Also, as noted above, in various embodiments, a subject may have an initial tissue manipulation position and the methods may include arranging the subject in such a position. An initial tissue manipulation position is a position of a subject's body immediately prior to and/or at the commencement of inducing relative motion between a first aspect, e.g., a first tissue, and second aspect, e.g., a second tissue, as described herein. An initial tissue manipulation position may include, for example, any one or combination of a: sitting position, lying position, anatomic position, decubitus position, supine position, prone position, dorsal recumbent position, right lateral recumbent position, left lateral recumbent position, tripod position, lithotomy position, knee-chest position, Fowler's position, high Fowler's position, low Fowler's position, Trendelenberg position, modified Trendelenberg position, or any combinations thereof.

In some versions of the disclosed methods, inducing relative motion between a first tissue and a second tissue includes moving the first tissue a first distance by, for example, applying pressure to the first tissue via a first contact area, and moving the second tissue a second distance. As noted above, in some aspects, applying pressure includes moving a first aspect, such as a first tissue, or a portion thereof, and/or a second aspect, such as a second tissue, or a portion thereof, a variety of distances, including a variety of distances with respect to one another.

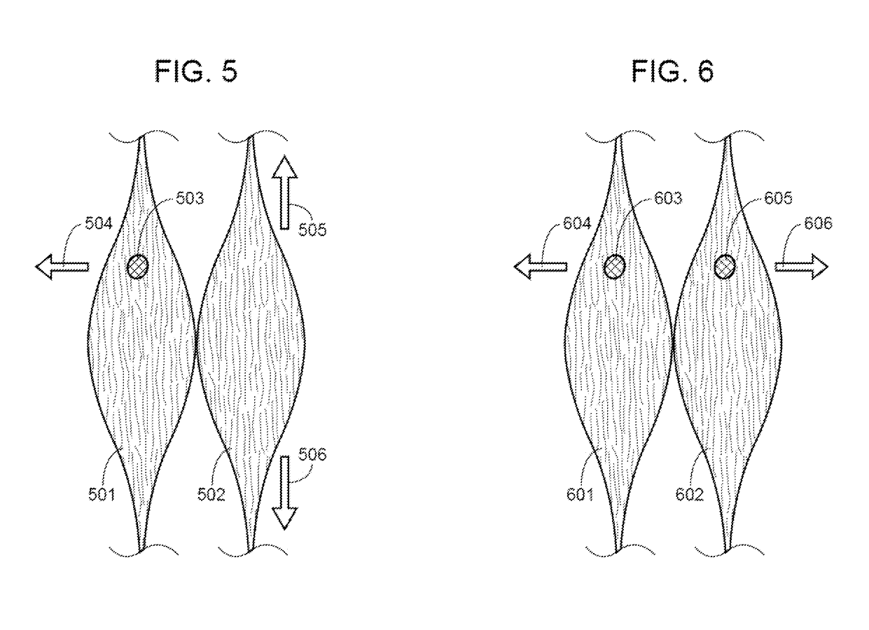

In some versions, applying pressure to a tissue includes a first step of moving the tissue, such as moving the tissue from a first position to a second position, and a second step of restricting movement of the tissue, such as restricting movement of the tissue in a second position. One version of an embodiment according to the subject methods is shown in FIG. 5 wherein applying pressure to first tissue 501 via contact area 503 moves the first tissue 501 in a direction 504, such as a direction away from a second tissue 502, such as an adjacent tissue. Such movement may thereafter substantially inhibit the first tissue 501 from moving while pressure is applied. After the first tissue 501 is moved, the second tissue 502 is moved, e.g., slid, for example, in one or more directions 505, 506, which may each be a natural tissue movement direction and/or may be a longitudinal direction. In some versions, moving the second tissue 502 includes inducing movement of at least a portion of the subject's body, such as by exerting an external force thereon and/or instructing the subject to move a portion of the subject's body, while pressure is applied to the first tissue 501.

In various aspects of the subject methods, the methods include a first step of moving a first tissue by applying pressure to the tissue, such as moving the tissue from a first position to a second position, and a second step, which may be performed simultaneously with the first step, of moving a second tissue by applying pressure to the tissue, such as moving the tissue from a first position to a second position. One version of such an embodiment is shown in FIG. 6 wherein applying pressure to first tissue 601 via contact area 603 moves the first tissue 601 in a direction 604, such as a direction away from a second tissue 602, such as an adjacent tissue. After and/or at the same time as the first tissue 501 is moved, the second tissue 502 is moved by applying pressure to second tissue 602 via contact area 605 moves the second tissue 602 in a direction 605, such as a direction away from a first tissue 601, such as an adjacent tissue.

Also, in some aspects of the subject methods, the methods include a first step of applying pressure to a first tissue and applying pressure to a second tissue. When pressure is applied to the first and second tissues, motion is induced between the first and second tissues. In some versions, such motion is induced by inducing movement of at least a portion of the subject's body while the pressure is applied to both the first and second tissues. Inducing movement of the portion of the subject's body may in turn cause the first tissue to move a first distance and the second tissue to move a second distance. The first and second distance may be in the same direction or in opposite directions. The first distance may have the same magnitude than the second distance or the magnitude of the first distance may be greater or less than that of the second distance.

In various aspects, inducing relative motion between a first aspect, such as a first tissue, and a second aspect, such as a second tissue, includes increasing freedom of movement between the first and second aspects, e.g., between the first tissue and the second tissue. Increasing freedom of movement refers to one aspect, e.g., tissue, being able to move, e.g., slide, more easily with respect to another aspect. Methods according to the subject embodiments may include increasing freedom of movement of a first aspect, such as a first tissue, with respect to a second aspect, such as a second tissue, and/or a first or second aspect with respect to one or more other aspects, such as a third tissue and/or additional tissues. Increasing freedom of movement of aspect, e.g., tissue of a subject, in some embodiments, includes making the aspect, e.g., tissue, more easily movable, e.g., more easily movable by the subject, in one or more of the aspect's natural movement directions. Such natural movement directions can include a first natural tissue movement direction and/or a second natural tissue movement direction opposite the first tissue movement direction. In some aspects, increasing freedom of movement between the first and second aspects, e.g., between the first tissue and the second tissue, includes restoring the degree of freedom of movement between the same aspects, e.g., tissues, that exists in a normal, healthy human.

In some versions of the subject methods, inducing relative motion between a first aspect, such as a first tissue, and a second aspect, such as a second tissue, includes reducing resistance to movement, of the first aspect, such as a first tissue, and/or a second aspect, such as a second tissue. Accordingly, aspects of the methods include increasing freedom of movement by, for example, removing and/or reducing, such as by tearing, such as by partially tearing, impediments to movement and/or the effects of impediments on movement. Such impediments to movement, in various embodiments include one or more tissues, such as one or more adhesions and/or lesions. As used herein, the term “adhesion” refers to one or more bands of tissue, such as fibrous tissue, such as scar tissue, that form between and/or connect tissues, e.g., soft tissues, and/or organs. Also, as used herein, the term “lesion” refers to a tissue abnormality which may be caused by trauma and/or disease. Lesions may occur on, in and/or between tissues, such as adjacent tissues. Movement of one or more tissues may also be impeded by fibrosis. As used herein, “fibrosis” refers to the formation of excess tissue, such as fibrous connective tissue, in a reactive and/or reparative process, such as wound healing. Fibrosis may occur in and/or between tissues, such as adjacent tissues. As such, aspects of the methods include increasing freedom of movement by, for example, removing and/or reducing, adhesions, lesions, and/or fibrosis, in, on, and/or between one or more tissues, such as a first tissue and/or a second tissue.

In some versions of the disclosed methods, inducing relative motion between a first tissue and a second tissue includes moving the first tissue a first distance and moving the second tissue a second distance. In some versions, the first distance is equal to the second distance. Also, in some versions, the first distance is longer than the second distance and in some versions, the second distance is longer than the first distance. According to some versions, the first distance is in a first direction, such as a natural tissue movement direction, and the second distance is in a second direction which is opposite the first direction. According to some versions, the first distance is in a first direction and the second distance is in the first direction. In other words, the first distance may also be in the same direction or an opposite direction as the second distance.

As noted above, some versions of the disclosed methods include inducing relative motion between a first aspect, e.g., tissue, and a second aspect, e.g., tissue. In various aspects, inducing relative motion between the first tissue and the second tissue includes applying pressure to the first tissue via a first contact area and/or applying pressure to the second tissue via a second contact area. In some instances, applying pressure to a tissue via a first contact area is performed before or after applying pressure to a second tissue via a second contact area. In some aspects, applying pressure to a tissue via a first contact area is performed while applying pressure to a second tissue via a second contact area.

In various aspects, the subject methods include applying pressure to the first tissue via a first contact area and applying pressure to the second tissue via a second contact area while moving the first tissue a first distance by inducing movement of at least a first portion of the subject's body which is operatively connected to the first tissue, and/or moving the second tissue a second distance by inducing movement of at least a second portion of the subject's body which is operatively connected to the second tissue. In various aspects, the subject methods include applying pressure to the first tissue via a first contact area or applying pressure to the second tissue via a second contact area while moving the first tissue a first distance by inducing movement of at least a first portion of the subject's body which is operatively connected to the first tissue, and/or moving the second tissue a second distance by inducing movement of at least a second portion of the subject's body which is operatively connected to the second tissue.

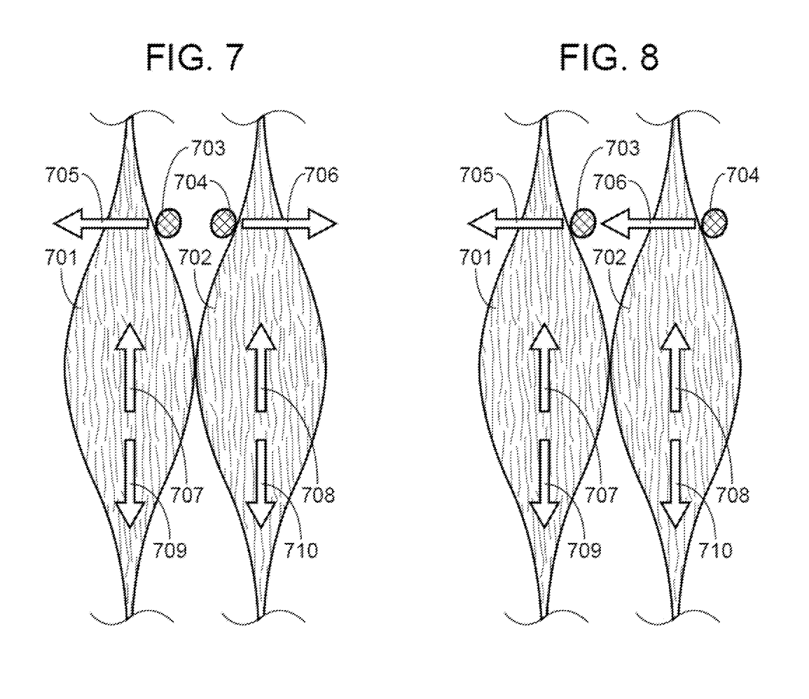

One version of the subject methods is provided in FIG. 7. As is illustrated in FIG. 7, in various embodiments of the methods, pressure may be applied to a tissue, e.g., a first tissue 701, via a contact area, e.g., a first contact area 703, in a first direction, such as inward and/or downward with respect to a subject's skin surface, and/or perpendicular to the surface of a subject's skin at a point of contact thereon. Simultaneously, the tissue, e.g., the first tissue 701, may be moved a distance in a second direction 705 and/or a third direction 706 by inducing movement of at least a portion, e.g., a first portion, of the subject's body which is operatively connected to the first tissue 701. The tissue, e.g., the first tissue 701, may be moved a distance in a second direction 705 while it is simultaneously being moved, in a first natural tissue movement direction 707. In some embodiments, the second direction 705 is transverse and/or perpendicular to the first direction and/or the first natural tissue movement direction 707. In various embodiments, the second direction 705 is a lateral direction. In various embodiments, the second direction 705 is parallel with the surface of the subject's skin above the tissue. Furthermore, in some embodiments of the methods, such as the version shown in FIG. 7, a first tissue 701 is initially adjacent to a second tissue 702.

Also, in some embodiments of the methods, pressure may be applied to a tissue, e.g., a second tissue 702, via a contact area, e.g., a second contact area 704, in the first direction, such as inward and/or downward with respect to a subject's skin surface, and/or perpendicular to the surface of a subject's skin at a point of contact thereon. Simultaneously, the tissue, e.g., the second tissue 702, may be moved a distance in the second direction 705 and/or a third direction 706 by inducing movement of at least a portion, e.g., a second portion, of the subject's body which is operatively connected to the second tissue 702. The tissue, e.g., the second tissue 702, may be moved a distance in a third direction 706 while it is simultaneously being moved, in a first natural tissue movement direction 708. In some embodiments, the third direction 706 is transverse and/or perpendicular to the first direction and/or the first natural tissue movement direction 708. In various embodiments, the third direction 706 is a lateral direction. In various embodiments, the third direction 706 is parallel with the surface of the subject's skin above the tissue. Also, in various instances, the second 705 and third 706 directions are opposite from one another. Accordingly, in some versions of the methods, the first tissue 701 and second tissue 702 are moved away from one another in opposite directions. Furthermore, in some instances, the first tissue 701 may be moved in a first natural tissue movement direction 707 and/or a second natural tissue movement direction 709 which is opposite the first. Also, the second tissue 702 may be moved in a first natural tissue movement direction 708 and/or a second natural tissue movement direction 710 which is opposite the first. In addition, a first natural tissue movement direction 707 and/or a second natural tissue movement direction 709 of a first tissue 701 may be parallel to a first natural tissue movement direction 708 of a second tissue 702 and/or a second natural tissue movement direction 710 of a second tissue 702.

Another version of the subject methods is provided in FIG. 8. FIG. 8 shares many of the same features as FIG. 7. However, FIG. 8 illustrates an embodiment wherein the first tissue 701 and second tissue 702 are moved synchronously instead of in opposite directions away from one another. The first tissue 701 and second tissue 702 are both moved in the same direction, e.g., the second direction 705.

In the embodiment of the methods of FIG. 8, the first contact area 703 is on a first side of the first tissue 701 and the second contact area 704 is on the first side of the second tissue 702. This is in contrast to the embodiment of FIG. 7 wherein the first contact area 703 is on a first side of the first tissue 701 and the second contact area 704 is on a second side of the second tissue 702 which is opposite the first side of the second tissue 702.

In the embodiments of FIGS. 7 and 8, the tissues are displaced as they slide along a contact area while the tissue or tissues are moved in a natural tissue movement direction. For example, in FIG. 8, the first tissue 701 is displaced in a second direction 705 by inducing movement of at least a portion, e.g., a first portion, of the subject's body which is operatively connected to the first tissue 701. Inducing the movement causes the first tissue 701, for example, to slide along contact area 703. Contact area 703 exerts a force against the first tissue 703 and causes it to move in a direction 705 away from the contact area 703. In various embodiments, sliding and corresponding displacement also occurs with each contact point shown in FIGS. 7 and 8. Also, according to the embodiments of FIGS. 7 and 8, the tissues may be displaced in the opposite direction as their original displacement as they slide along a contact area while the tissue or tissues are moved in a second natural tissue movement direction opposite a first natural tissue movement direction.

Furthermore, in various embodiments including those shown in FIGS. 7 and 8, the one or more contact areas, e.g., first contact area 703, are adjacent to one or more tissues, e.g., first tissue 701. In versions of the embodiments in which one or more contact areas are adjacent to tissues, e.g., target tissues to be moved, pressure may be applied to a tissue via a contact area in the first direction, such as inward and/or downward with respect to a subject's skin surface, and/or perpendicular to the surface of a subject's skin at a point of contact thereon. However, applying pressure via a contact area may also include exerting a force on a tissue, such as a tissue adjacent to the contact area in a tissue displacement direction. It may also include displacing a tissue in the tissue displacement direction. For example, as shown in FIG. 7, the second 705 and third 706 directions are each tissue displacement directions. Such a tissue displacement direction may be transverse and/or perpendicular and/or substantially perpendicular to the direction in which pressure is applied to the contact area via the skin's surface. Such a tissue displacement direction may also be transverse and/or perpendicular and/or substantially perpendicular to one or more natural tissue movement directions, e.g., a first natural tissue movement direction 707, 708 and/or a second natural tissue movement direction 709, 710.

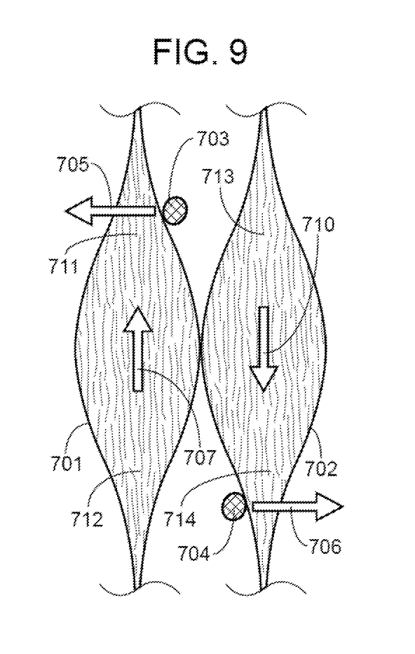

Another version of the subject methods is provided in FIG. 9. FIG. 9 shares many of the same features as FIGS. 7 and 8. FIG. 9 illustrates an embodiment wherein portions of the first tissue 701 and second tissue 702 are moved in opposite directions away from one another. FIG. 9 shows the first tissue 701 having a first portion, e.g., a first end 711 and a second portion, e.g., a second end 712. Also, the second tissue 702 has a first portion, e.g., a first end 713 and a second portion, e.g., a second end 714. In the embodiment of the methods of FIG. 9, the first contact area 703 is on a first side of the first tissue 701 and the second contact area 704 is on a second side of the second tissue 702 which is opposite the first side of the second tissue 702. As is shown, the first tissue 701 may be moved in a first natural tissue movement direction 707 while the second tissue 702 may be moved in a second natural tissue movement direction 710. Such movement will cause the first end 711 of the first tissue 701 to move in a second direction and will cause the second end 714 of the second tissue 702 to move in a third direction. Accordingly, moving tissues, such as adjacent tissues, each in a natural movement direction, such as opposite natural movement directions, in such a configuration, will cause the tissues, or one or more portions thereof, e.g., one or more ends, to move away from each other.

Also, in various embodiments, one or more contact areas, e.g., a first contact area 703 and/or second contact area 704, may be at or adjacent to a first portion, e.g., a first end, and/or a second portion, e.g., a second end of one or more tissues, such as adjacent tissues, and/or a first and second tissue. As is shown in FIGS. 7-9, such contact areas may both be at the same ends of adjacent tissues or may be at opposite ends of such tissues. One or more of such contact areas may also be at and/or adjacent to a midpoint between a first end and a second end of a tissue.

In some versions, inducing movement of a first and/or second portion of the subject's body includes exerting an external force on the first and/or second portion of the subject's body being moved. In some aspects, inducing movement of a first and/or second portion of the subject's body includes instructing the subject to move the first and/or second portion of the subject's body.

The methods, as disclosed herein, include or are embodiments of treating a subject for one or more tissue ailment. The terms “treating” and “treatment”, as used herein, refer to taking one or more actions, such as following one or more of the protocols described herein, to alleviate the ailment and/or symptoms of the ailment. Symptoms of ailments disclosed herein, e.g., the tissue ailments, may include but are not limited to discomfort, such as pain and/or tingling and/or aching, and/or burning, and/or numbness and/or hypersensitivity and/or weakness, and/or stiffness, and/or atrophy, and/or circulatory changes, in a part of a subjects body and treatment may include alleviating or eliminating any one or combination of such symptoms. Taking one or more actions to treat a subject may include not taking action or not taking immediate action to treat the ailment. The subject methods also include substantially alleviating an ailment, e.g., a tissue ailment, and/or symptoms of the ailment, e.g., a tissue ailment, in a subject temporarily, e.g., for a period of time of 5 minutes or more, such as one hour or more, such as one day or more, such as one month or more, such as one year or more, such as five years or more, and/or for the remaining life of the subject. In addition, the methods disclosed herein may include or are treatments, such as chiropractic treatments.

By “tissue ailment” as used herein, is meant a disorder of one or more tissue which may produce symptoms, such as discomfort, e.g., pain, and/or restriction of movement, e.g., stiffness, in a subject. As such, a tissue ailment includes at least one difference between the tissue associated with the ailment and/or its function, and the same type of tissue and/or its function in a normal, healthy human. In various embodiments, a tissue ailment is an ailment of soft tissue. Also, in some versions of the methods, the ailments are conditions and/or disorders of one or more subcutaneous tissues, such as muscles, tendons, ligaments, fascia and/or nerves. Ailments according to the subject embodiments may include but are not limited to, for example, carpal tunnel syndrome, shin splints, sciatica, plantar fasciitis, tennis elbow, or any combinations thereof. Such ailments may also include tendonitis, bursitis, patellofemoral pain, IT band syndrome, cubital tunnel syndrome, epicondylitis, tenosynovitis, myofascitis, peripheral nerve entrapment, thoracic outlet syndrome, and De Quervain's disease, or any combinations thereof.

Additionally, symptoms of the ailments disclosed herein, e.g., the tissue ailments, may include but are not limited to, discomfort, such as pain and/or tingling and/or aching, and/or burning, and/or numbness and/or hypersensitivity and/or weakness, and/or atrophy, and/or circulatory changes, in a part of a subjects body. For example, symptoms may include pain in a body part or substantially in a body part, such as back pain, arm pain, leg pain, shoulder pain, knee pain, head pain, neck pain, elbow pain, wrist pain, finger pain, ankle pain, toe pain, or any combinations thereof. Symptoms of the ailments disclosed herein may also include a full or partial restriction or limit of motion, e.g., a restriction in the ability of a subject to freely move a portion of the subject's body, such as a stiffness. For example, symptoms may include stiffness in a body part or substantially in a body part, such as back stiffness, arm stiffness, leg stiffness, shoulder stiffness, knee stiffness, head stiffness, neck stiffness, elbow stiffness, wrist stiffness, finger stiffness, ankle stiffness, toe stiffness, or any combinations thereof. Symptoms of the subject disclosure may also include a complete inability of a subject to move one or more portions of the subject's body, such as the subject's back, arm, leg, shoulder, knee, head, neck, elbow, wrist, finger, ankle, toe, or any combinations thereof without external assistance.

Furthermore, symptoms may include a decrease in the functional movement of one or more portions of a subject's body. By “functional movement” is meant the amount a subject, e.g., a subject experiencing one or more symptoms of an ailment or a normal, healthy human, can move, e.g., extend, retract and/or rotate, a portion of the subject's body, e.g., an appendage, without external assistance or without substantial discomfort. In some aspects, a decrease in the functional movement of one or more portions of a subject's body may include a decrease, e.g., a substantial decrease, of 1% or more, 5% or more, 10% or more 20% or more, 50% or more, or 90% or more, with respect to the subject's original range of functional movement or the range of functional movement in a normal, healthy human.

According to some embodiments of the methods, an ailment includes one or more overuse conditions, such as soft tissue overuse conditions, such as muscle overuse conditions. Overuse conditions are conditions related to or exacerbated by overuse of one or more body parts. Overuse refers to repetitive use, e.g., use including repetitive motion or motions, resulting in damage to tissue and/or repair of damaged tissue which causes a subject to experience one or more symptoms. Since ailments may include muscle overuse conditions, the subject methods include substantially alleviating one or more overuse conditions, and/or symptoms of one or more overuse conditions, in a subject temporarily, e.g., for a period of time of 5 minutes or more, such as one hour or more, such as one day or more, such as one month or more, such as one year or more, such as five years or more, and/or for the remaining life of the subject. Overuse conditions may include but are not limited to, for example, carpal tunnel syndrome, shin splints, sciatica, plantar fasciitis, tennis elbow, tendonitis, bursitis, e.g., bursitis of the knee or elbow or trochanteric bursitis, patellofemoral pain, IT band syndrome, cubital tunnel syndrome, epicondylitis, tenosynovitis, myofascitis, peripheral nerve entrapment, thoracic outlet syndrome, and De Quervain's disease, e.g., tenosynovitis, or any combinations thereof. In addition, overuse conditions and/or tissue ailments, as disclosed herein, may include but are not limited to: Stress Fracture, e.g., Stress Fracture in the feet; Achilles Tendon Rupture; Achilles Tendonitis/Tendinitis; Calf Muscle Tear; Chondromalacia Patella; Degenerative Disc Disease; Femoroacetabular Impingement (FAI); Fibromyalgia; Golfers Elbow; Hip Labral Tear; ITB Syndrome; Knee Replacement; Meniscus Tear; Metatarsalgia; Morton's Neuroma; Muscle Strain (Muscle Pain); Neck Arm Pain; Osgood Schlatter's; Osteitis Pubis; Patella Tendonitis (Tendinopathy); Poor Hip Core; Rotator Cuff Syndrome; RSI—Repetitive Strain Injury; Sacroiliac Joint Pain; Severs Disease; Side Strain (Abdominal); Sinding Larsen Johansson Syndrome; Spondylolisthesis; Spondylolysis (Back Stress Fracture), or any combinations thereof. Furthermore, overuse conditions may have any one or combination of the symptoms of the ailments provided herein.

Tissue ailments may result from repetitive motion injuries, constant pressure or tension injuries and/or acute injuries. Acute injuries are injuries which include tearing of muscle and/or fascia and may also trigger biological processes involving white blood cells, the production of fibrinogen, and/or the growth of adhesions. Repetitive motion injuries and constant pressure or tension injuries may also result in the growth of adhesions. Tissue ailments may also result from injuries not involving trauma, e.g., acute tissue trauma, such as a tearing of soft tissue, such as muscle and/or fascia. Tissue ailments according to the embodiments may result in the formation of one or more tissue adhesions and/or lesions, which in turn, might result in a subject experiencing one or more symptoms.

Tissue ailments according to the embodiments may result from one or more cumulative injuries, e.g., a cumulative trauma disorder or and/or a cumulative injury disorder. Cumulative injuries resulting in ailments described herein, including tissue ailments, are injuries which result from the law of repetitive motion and the cumulative injury cycle. The law of repetitive motion may be modeled as:

I=NF/AR

In this formula, I is a relative quantity denoting an insult to one or more tissues; N is a number of repetitions; F is the force or tension of each repetition as a percent of maximum muscle strength; A is the amplitude of each repetition; and R is the relaxation time between each repetition. For example, a jackhammer operator may be exposed regularly to vibrations wherein N is high, A is low, and R is low. In such a circumstance, I therefore would be high. The formula above indicates that injuries may derive from constant pressure or tension that is without apparent or immediate trauma to soft tissues. Also, cumulative injuries may result from isometric muscle contractions and/or poor posture with consequences including, for example, cellular calcium retention, poor cellular repair, and/or altered function.

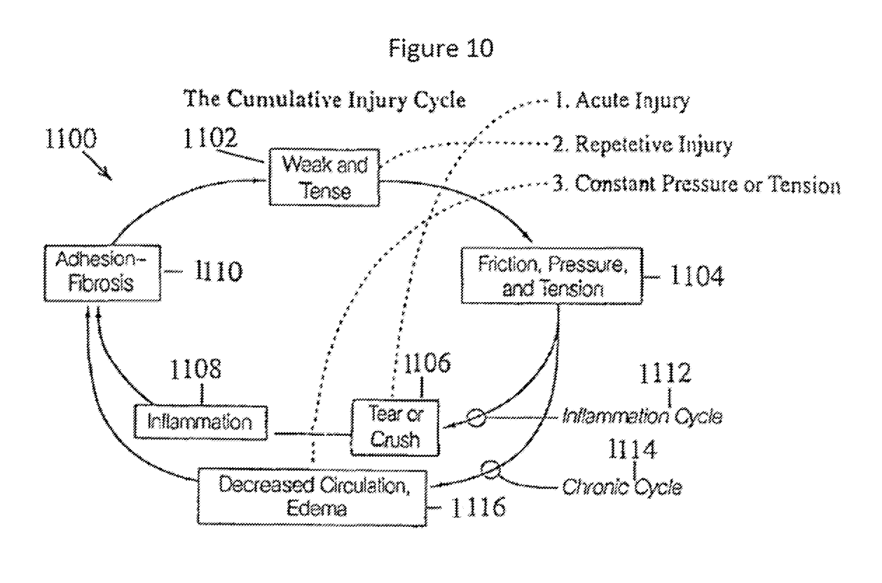

Repetitive motion injuries, constant pressure or tension injuries and/or acute injuries may all contribute to a cumulative injury cycle 1100, as shown for example in FIG. 10. Repetitive motion injuries may result in weak and tense tissues 1102. Tissues that are adjacent to these weak and tense tissues may also be drawn tight. Weak and tense tissues produce corresponding internal forces 1104 including friction and pressure. An acute injury 1106, such as tearing or crushing on a microscopic or macroscopic level, can result from these internal forces. An isolated acute injury 1106 can also commence cycle 1100. Inflammation 1108 results from the acute injury 1106, and exacerbates the total problem by enhancing the weakness and tenseness of the injured tissues. Internal forces 1104 also induce decreased circulation or edema 1108. The effect of these internal forces is usually a decrease in circulation. The acute injury 1106 and inflammation 1108 contribute to cellular hypoxia from restricted circulation. This cellular hypoxia causes fibrosis and adhesions 1110 to occur in and between tissues. Acute injury 1106 and inflammation 1108 combine to form an inflammation cycle 1112 leading to adhesion and fibrosis 1110. A chronic cycle 1114 also leads towards adhesion and fibrosis 1110. Chronic cycle 1114 includes the effects of decreased circulation and edema 1116. As indicated above, internal forces 1104 lead to a decrease in circulation and an increase in internal pressure. The decrease in circulation may be enhanced by the continued application of external pressure, e.g., as from an elastic garment. Pressure applied over a low-pressure lymphatic channel causes swelling or edema, which also leads to adhesion and fibrosis 1110.

Also, various subjects may be predisposed to be more severely affected than others by injuries on the cumulative injury cycle 1100. For example, smokers and diabetics have relatively poor circulation, which helps perpetuate the cycle. Thyroid deficits and hormonal changes increase musculature tension, and enhance the degree of weakness and tightness in the affected tissues. The cumulative injury cycle 1100 perpetuates itself, and afflicted persons find themselves in a downward spiral until the symptoms and syndromes of cumulative injury disorder are prevalent.

The subject methods, in some aspects, also include diagnosing a subject with one or more of the ailments, e.g., tissue ailments described herein, e.g., muscle overuse conditions. Diagnoses of such ailments may be made using any convenient protocol to identify one or more ailments or characteristics thereof. For example, diagnosing a subject may include assessing one or more symptoms exhibited and/or expressed by the subject. Such assessment may include investigating or recognizing one or more characteristics thereof, such as a location of symptoms in the body of the subject or the effects thereof on the performance of the body of the subject. Such symptoms may include, for example, discomfort, such as pain and/or tingling and/or aching, and/or burning, and/or numbness and/or hypersensitivity and/or weakness, and/or atrophy, and/or circulatory changes, and/or a full or partial restriction of motion in one or more body parts of the subject in a part of a subjects body.

In various embodiments, diagnosing a subject includes assessing functional movement of one or more portions of a subject's body. As noted above, “functional movement” refers to the amount a subject, e.g., a subject experiencing one or more symptoms of an ailment or a normal, healthy human, can move, e.g., extend, retract and/or rotate, a portion of the subject's body, e.g., an appendage, without external assistance or without substantial discomfort. As such, diagnosing may include determining that functional movement of a portion of a subject's body is affected, e.g., decreased, e.g., decreased by a tissue ailment, compared to the subject's original range of functional movement or the range of functional movement of a normal, healthy human. Diagnosing may also include determining and/or estimating the amount which functional movement of a portion of a subject's body is decreased, e.g., decreased by a tissue ailment, compared to the subject's original range of functional movement or the range of functional movement of a normal, healthy human. Diagnosing a subject, in some embodiments, includes assessing functional movement of one or more portions of a subject's body such as one or more joints and/or a subject's back, arm, leg, shoulder, knee, head, neck, elbow, wrist, finger, ankle, toe, or any combinations thereof.

Diagnosing a subject may include comparing one or more symptoms exhibited and/or expressed by the subject with symptoms previously expressed by other subjects having one or more ailment, such as a tissue ailment, such as a known tissue ailment. As such, diagnosing may include a provider remembering symptoms or characteristics of ailments previously exhibited or expressed by other subjects. Diagnosing may also include accessing one or more tools, such as media tools, such as a printed publication, e.g., a book, and/or video and/or computer program, which retains and/or exhibits one or more characteristics of symptoms previously exhibited or expressed by other subjects. For example, diagnosing may include referencing a book or computer program showing common characteristics, e.g., locations, of symptoms on or in the body of a subject for a subject having a particular tissue ailment. Such characteristics, e.g., locations, can then be compared to characteristics of symptoms currently being expressed or exhibited by a subject being diagnosed.

Diagnosing and/or differentiating two or more aspects, e.g., tissues, may include applying one or more tools, such as media tools, such as a printed publication, e.g., a book, and/or video and/or computer or aspect thereof, e.g., a computer program. Such tools may include one or more symptom pattern images or charts. Also, where tools include one or more computers, the computers may each include one or more input device, e.g., a mouse and/or keyboard, and/or controller and/or display.

Tools, such as media tools according to the subject disclosure, may each include, for example, one or more aspects for storing and/or displaying one or more symptom pattern charts and/or for associating each of the charts with one or more corresponding treatment protocols. An associating aspect for associating each of the charts with one or more corresponding treatment protocols may include one or more identifiers, e.g., numbers, that are shared between the respective symptom pattern charts their corresponding expert treatment protocols. The disclosed tools may include a computer database and/or computer program that performs or assists in the function of displaying one or more selected treatment protocols. Such tools may operate, for example, by storing and/or executing instructions to perform such tasks. The disclosed tools may also include one or more printed publications, such as a book, including cross indexed symptom pattern charts and treatment protocols.

One or more of the media tools disclosed herein may also be applied in training others to treat patients according to the claimed methods. As such, the methods include teaching one or more practitioners, e.g., medical practitioners, to apply the subject methods. Such methods may include holding seminars and/or classes where actual and/or simulated patients are treated. Teaching the subject methods may, in some versions, include use of visual displays, e.g., overhead transparencies, computer displays, or audio visual presentations, such as videos. Such visual displays may be used to show representations, e.g., pictures, of actual and/or simulated treatments or aspects thereof.

In some versions of the methods, a medical practitioner and/or a patient study one or more of the symptom pattern images or charts. Each symptom pattern image provides an association between an anatomical image showing a portion of the human body and an expert-derived symptom pattern that is superposed on the anatomical image. The expert-derived symptom pattern depicts an anatomical area where a medical expert has determined that one or more symptoms of the conditions and/or ailments described herein may occur.

The tools may also include an identifier for associating each of the respective symptom pattern images with one or more corresponding treatment protocols, e.g., expert treatment protocols, which may include any of the disclosed methods. Both the symptom pattern images and the treatment protocols may also include a cross-reference list of related treatment protocols. Such a cross-reference list may allow an effective treatment to be implemented, for example, from a plurality of diagrams, without a confirmed diagnosis ever having been made.

In some versions, the methods include commencing and/or performing one or more of the methods described herein, e.g., the methods of treatment, without making a diagnosis or before a diagnosis or evaluation, e.g., an evaluation of all symptoms, has been completed. In some aspects, a patient is interviewed to identify the anatomical area or areas on the patient's body where the patient is experiencing one or more symptoms. Such an anatomical area is referred to herein as the patient's symptom pattern. The locus of the patient's symptom pattern is matched with a selected symptom pattern image. The selected symptom pattern image is selected from a plurality of such images, which may be displayed to the patient from a media tool as described herein, e.g., a printed publication such as a book, computer database, or wall chart. Thus, matching of the patient's symptom pattern with a symptom pattern image may occur by asking the patient to select a symptom pattern chart that shows an expert-derived symptom pattern corresponding to the locus of the patient's symptoms. A medical practitioner who implements a treatment may assist the patient's selection of an appropriate symptom pattern chart by suggesting selected symptom pattern charts and recalling them from storage to present them for the patient's review.

A selected symptom pattern chart may be associated, for example by an identifier, with one or more expert treatment protocols. For example, an identifier can be a number of a corresponding expert treatment protocol, and the number can be found as indicia on the symptom pattern chart. The expert treatment protocol may be applied to diagnose and treat a tissue aliment and/or condition. If the selected treatment fails to alleviate the symptoms that the patient has been experiencing, then another treatment protocol may be selected and implemented, for example, from a cross-reference list of related treatment protocols. A shared identifier may be used to match the symptom pattern image with a corresponding treatment protocol for appropriate recall on demand.

According to various embodiments, the methods include techniques for manually manipulating a portion of a patient's body to effect treatment of a tissue ailment and/or a condition. Such manipulation may occur at or proximate a locus of the expert-derived symptom pattern and/or the patient's symptom pattern as directed by the expert treatment protocol. In some aspects, the methods also include inducing motion of a portion of a subject's body. In some versions, media tools and/or expert treatment protocols facilitate manipulation, and the inducement of such motion, for example by providing a representation, e.g., an anatomical diagram, showing the location of subcutaneous tissues involved in active motion and/or a representation of how a portion of a subject's body should be moved.

In some versions, the methods include confirming a diagnosis during treatment, e.g., after the initial implementation of one or more of the described methods for treatment. As such, in some versions of the methods, a treatment is selected and initially implemented without a treatment provider having performed an initial diagnosis. In such cases, a diagnosis may be made while simultaneously moving one or more aspects, e.g., tissues, and/or inducing one or more portions of a portion of a body to move.

In various embodiments, the methods include a step, e.g., an initial step, of displaying, e.g., displaying to a subject, a plurality of symptom pattern images. Such symptom pattern images may be displayed to a subject, e.g., patient, in need of treatment. At the same time as the symptom pattern images are being displayed to the patient, they may also be displayed to a practitioner who can implement treatment according to the subject methods. Thus, for example, the practitioner can suggest and/or discuss appropriate symptom pattern images with the patient. Suitable applications for displaying these images include any of the media tools disclosed herein, such as a printed publication, e.g., a book, photographic slide projector or, a computerized image storage and retrieval system driven by object-oriented code.

In some versions, an identifier, such as a number and/or letter sequence, is associated with each symptom pattern image. The identifier may be applied for associating a selected symptom pattern image with a corresponding treatment protocol. Accordingly, in some aspects, the methods include associating a symptom pattern image with a corresponding treatment protocol. Such an association may be made by use of the identifiers which correspond to the selected symptom pattern image. In some versions, a single symptom pattern image may be associated with a plurality of identifiers corresponding to a plurality of treatment protocols. A darkened area of a symptom pattern image representing a corresponding expert-derived symptom pattern may be superposed on each anatomical base image. The respective expert-derived symptom patterns may each cover different localized anatomical areas with respect to the underlying base anatomical image. For example, an expert-derived symptom pattern may be located on the neck of anatomical image, while a symptom pattern is located on the chest of anatomical image. Also, a first expert-derived symptom pattern may occupy a smaller area than a second expert-derived symptom pattern.

The locations, e.g., anatomical locations, of the expert-derived symptom patterns may be selected by medical practitioners who have extensive experience in diagnosing and treating soft tissue lesions or adhesions. The symptom patterns can identify the respective locations of symptoms including any of the symptoms disclosed herein, including numbness, tingling, pain, ache, burning, weakness, atrophy, circulatory changes, hypersensitivity, restricted motion, and combinations of these symptoms, which are associated with specific types of tissue ailments and/or conditions. Expert medical practitioners who may be qualified to identify the location of these symptom patterns include medical doctors, chiropractors, physician's assistants, nurses, e.g., nurse practitioners and/or registered nurses, and other medical professionals.

The subject methods also may include selecting a symptom pattern image having an expert-derived symptom pattern that most closely covers or resembles the areal extent of symptoms that the patient is experiencing. In some versions, the patient or the medical practitioner decides which symptom pattern image best corresponds to the patient's symptoms. In some instances, the medical practitioner who intends to implement treatment suggests various symptom pattern images for the patient to review, in order to facilitate making the most appropriate selection. In some versions, the methods include eliminating one or more treatment protocol options based on, for example, one or more symptom pattern image.

The media tools disclosed herein, in some embodiments, include media content having a section, e.g., a functional anatomy section, which describes and/or depicts in detail the anatomical location of the soft tissues proximate to where treatment is to be implemented, suggested methods for working or manipulating tissues proximate the anatomical location, a diagnosis corresponding to a selected symptom pattern image, and/or a cross-reference list of related treatment protocols. A section, e.g., a treatment section, of the media content may provide additional detail with respect to how treatment should be implemented. Subsections of the treatment section may include a contact subsection describing the part or parts of the provider's hand or hands used to contact the patient. A pressure tension subsection may provide a relative index of how much pressure and/or tension are required to effect treatment at a contact area. A contact motion subsection may describe what type of internal and/or external motion should be associated with manipulation of the patient at the contact area. A patient motion subsection may describe whether a patient should move actively and/or passively. An instructions subsection may provide details of how a medical practitioner should manipulate the patient. A notes subsection may provide additional comments and considerations to help assure that treatment is being properly implemented.

Additional aspects of treatment protocol or media content for playing on the disclosed media tools associated therewith may include accessed illustrations and/or images and/or videos, e.g., sequentially accessed illustrations, of a treatment protocol being implemented on an subject. Such depictions may include one or more anatomical diagram. Furthermore, a series of illustrations and/or images and/or videos may depict the implementation of a treatment as designated in a treatment subsection of media content. A series of illustrations and/or images and/or videos may also depict a plurality of alternative treatment protocols.

In some aspects, the methods include confirming a diagnosis by interviewing the patient to determine whether the selected treatment protocol has reproduced one or more of the symptoms that the patient has been experiencing. In some versions, a treatment or an aspect thereof reproduces, e.g., exacerbates and/or results in, some or all of such symptoms.

In some versions, the methods include performing a related treatment protocol after performing a first treatment protocol. A related treatment protocol may be one provided in a related treatment protocol section of media content. Such separate protocols may be implemented by a repetition of various steps using the new modalities that are associated with each new protocol. Additional treatment protocols may be used when a medical practitioner has been unable, even after treatment, to make a diagnosis and/or when a treatment has failed to reproduce one or more symptoms in the patient.

According to various embodiments, exemplary pairings of first and second tissues, respectively, and/or second and first tissues, respectively, wherein the tissues are tissues of a body part, such as an appendage or a portion thereof, such as an upper extremity or a portion thereof, such as an arm or a portion thereof, such as a hand, include, but are not limited to: Lumbricals|Flexor digitorum longus tendons; second Lumbrical/first Interosseous; Adductor pollicis|Flexor pollicis brevis; Abductor pollicis|Opponens pollicis; Abductor pollicis brevis|Flexor pollicis brevis; Extensor indicis|Extensor pollicis longus; Abductor pollicis longus|Extensor pollicis brevis; Flexor digiti minimi|Abductor digiti minimi; Opponens digiti minimi|Abductor digiti minimi; Flexor digiti minimi|Opponens digiti minimi, or any combinations thereof.

In some embodiments of the methods, exemplary pairings of first and second tissues, respectively, and/or second and first tissues, respectively, wherein the tissues are tissues of a body part, such as an appendage or a portion thereof, such as an upper extremity or a portion thereof, such as an arm or a portion thereof, such as an anterior portion of an arm, include, but are not limited to: Flexor pollicis longus|Pronator quadratus; Pronator quadratus|Flexor carpi ulnaris; Flexor digitorum superficialis|Flexor digitorum profundus; Pronator teres|Brachioradialis; Pronator teres|Flexor carpi radialis; Pronator teres|Flexor digitorum superficialis; Flexor carpi radialis|Flexor digitorum superficialis; Flexor pollicis longus|Flexor carpi radialis, or any combinations thereof.

In various embodiments of the subject methods, exemplary pairings of first and second tissues, respectively, and/or second and first tissues, respectively, wherein the tissues are tissues of a body part, such as an appendage or a portion thereof, such as an arm or a portion thereof, such as a lateral portion of an elbow, include, but are not limited to: Brachioradialis|Extensor carpi radialis longus; Extensor carpi radialis longus|Brevis; Extensor carpi radialis brevis|Extensor digitorum; Extensor carpi ulnaris|Extensor digitorum; Supinator|Extensor digitorum; Anconeus|Extensor carpi ulnaris; Extensor indicis|Extensor carpi ulnaris, or any combinations thereof.

According to various embodiments, exemplary pairings of first and second tissues, respectively, and/or second and first tissues, respectively, wherein the tissues are tissues of a body part, such as an appendage or a portion thereof, such as an upper extremity or a portion thereof, such as an arm or a portion thereof, such as an anterior brachium, include, but are not limited to: Biceps|Coracobrachialis;

Biceps|Brachialis; Coracobrachialis|Brachialis, or any combinations thereof.

In some embodiments, exemplary pairings of first and second tissues, respectively, and/or second and first tissues, respectively, wherein the tissues are tissues of a body part, such as an appendage or a portion thereof, such as an upper extremity or a portion thereof, such as an arm or a portion thereof, such as a shoulder, include, but are not limited to: Pectoralis major|Pectoralis minor; Pectoralis major|Subclavius; Deltoid|Pectoralis major; Pectoralis major|Biceps; Deltoid|Biceps; Deltoid/Infraspinatus|Biceps; Deltoid/Infraspinatus & teres minor; Deltoid|Triceps; Teres minor|Teres major; Latissimus dorsi & teres major|Triceps; Triceps|Teres minor; Trapezius|Supraspinatus; Teres major|Latissimus dorsi; Rhomboid|Trapezius; Serratus posterior superior|Rhomboid; Posterior scalene|Levator scapulae; Levator scapulae|Trapezius; Serratus anterior|Latissimus dorsi; Serratus anterior|Subscapularis, or any combinations thereof.

In various embodiments of the methods, exemplary pairings of first and second tissues, respectively, and/or second and first tissues, respectively, wherein the tissues are tissues of a body part, such as an appendage or a portion thereof, such as lower extremity or a portion thereof, such as an leg or a portion thereof, such as a foot, include, but are not limited to: Flexor digitorum brevis|Plantar aponeurosis; Flexor digitorum brevis|Flexor digitorum longus; Flexor digiti minimi|Abductor digiti minimi; Quadratus plantae|Flexor digitorum brevis; Flexor hallucis brevis|Abductor halluces; Adductor hallucis|Flexor hallucis brevis; Adductor hallucis|Flexor digitorum; Lumbricals|Flexor digitorum longus tendons; Extensor hallucis brevis|Extensor digitorum brevis, or any combinations thereof.

According to some embodiments, exemplary pairings of first and second tissues, respectively, and/or second and first tissues, respectively, wherein the tissues are tissues of a body part, such as an appendage or a portion thereof, such as lower extremity or a portion thereof, such as an leg or a portion thereof, such as a lower portion of a leg, e.g., a portion below the knee, include, but are not limited to: Tibialis anterior|Extensor hallucis longus; Extensor hallucis longus|Extensor digitorum longus; Tibialis anterior|Extensor digitorum longus; Flexor digitorum longus|Tibialis posterior; Tibialis posterior|Flexor hallucis longus; Flexor digitorum longus|Soleus; Flexor hallucis longus|Soleus; Gastrocnemius|Soleus; Popliteus|Gastrocnemius; Distal hamstring|Proximal gastrocnemius, or any combinations thereof.

In some versions, exemplary pairings of first and second tissues, respectively, and/or second and first tissues, respectively, wherein the tissues are tissues of a body part, such as an appendage or a portion thereof, such as lower extremity or a portion thereof, such as an leg or a portion thereof, such as an upper portion of a leg, e.g., a portion above the knee, include, but are not limited to: Adductors|Gracilis; Adductors|Hamstrings; Biceps long|short heads; Medial hamstrings|Lateral hamstrings; Rectus femoris|Vastus intermedius; Vastus medialis|Sartorius; Vastus lateralis|Illiotibial band; Adductors|Sartorius; Sartorius|Rectus femoris;

Pectineus|Adductors, or any combinations thereof.

According to some embodiments, exemplary pairings of first and second tissues, respectively, and/or second and first tissues, respectively, wherein the tissues are tissues of a body part, such as an appendage or a portion thereof, such as lower extremity or a portion thereof, such as an leg or a portion thereof, such as a hip, include, but are not limited to: TFL|Gluteus medius; Gluteus maximus|medius; Quadratus femoris|Inferior gemellus; Superior Gemellus & Piriformis|Gluteus medius & minimus, or any combinations thereof.

In embodiments of the disclosed methods, exemplary pairings of first and second tissues, respectively, and/or second and first tissues, respectively, wherein the tissues are tissues of a body part, such as a spine or a portion thereof, such as a lumbar portion of the spine, include, but are not limited to: Quadratus lumborum|Erectors; Multifidus|Erectors; Rotator|Multifidus (Lumbar); Serratus posterior inferior|Latissimus dorsi; Psoas|Iliacus; Semispinalis|Erectors, or any combinations thereof.

In some versions of the methods, exemplary pairings of first and second tissues, respectively, and/or second and first tissues, respectively, wherein the tissues are tissues of a body part, such as a spine or a portion thereof, such as a thoracic portion of the spine, include, but are not limited to: Rotator|Multifidus (Thoracic); Multifidus|Semispinalis; External oblique|Internal oblique, or any combinations thereof.

According to various embodiments, exemplary pairings of first and second tissues, respectively, and/or second and first tissues, respectively, wherein the tissues are tissues of a body part, such as a spine or a portion thereof, such as a cervical portion of the spine, include, but are not limited to: Rectus capitis minor|Rectus capitis major; Semispinalis capitis|Rectus capitis; Semispinalis capitis|Splenius capitis; Splenius capitis|Trapezius; Scalenes|Omohyoid, or any combinations thereof.

A first aspect and/or a second aspect, such as a first tissue and/or a second tissue, according to various embodiments of the subject disclosure, may include or be, but are not limited to, any of the following: Lumbricals; Flexor digitorum longus tendons; second Lumbrical; first Interosseous; Adductor pollicis; Flexor pollicis brevis; Abductor pollicis; Opponens pollicis; Abductor pollicis brevis; Flexor pollicis brevis; Extensor indicis; Extensor pollicis longus; Abductor pollicis longus; Extensor pollicis brevis; Flexor digiti minimi; Abductor digiti minimi; Opponens digiti minimi; Abductor digiti minimi; Flexor digiti minimi; Opponens digiti minimi; Flexor pollicis longus; Pronator quadratus; Pronator quadratus; Flexor carpi ulnaris; Flexor digitorum superficialis; Flexor digitorum profundus; Pronator teres; Brachioradialis; Pronator teres; Flexor carpi radialis; Pronator teres; Flexor digitorum superficialis; Flexor carpi radialis; Flexor digitorum superficialis; Flexor pollicis longus; Flexor carpi radialis; Brachioradialis; Extensor carpi radialis longus; Extensor carpi radialis longus; Brevis; Extensor carpi radialis brevis; Extensor digitorum; Extensor carpi ulnaris; Extensor digitorum; Supinator; Extensor digitorum; Anconeus; Extensor carpi ulnaris; Extensor indicis; Extensor carpi ulnaris; Biceps; Coracobrachialis; Biceps; Brachialis; Coracobrachialis; Brachialis; Pectoralis major; Pectoralis minor; Pectoralis major; Subclavius; Deltoid; Pectoralis major; Pectoralis major; Biceps; Deltoid; Biceps; Deltoid; Infraspinatus; Biceps; Deltoid; Infraspinatus & teres minor; Deltoid; Triceps; Teres minor; Teres major; Latissimus dorsi & teres major; Triceps; Triceps; Teres minor; Trapezius; Supraspinatus; Teres major; Latissimus dorsi; Rhomboid; Trapezius; Serratus posterior superior; Rhomboid; Posterior scalene; Levator scapulae; Levator scapulae; Trapezius; Serratus anterior; Latissimus dorsi; Serratus anterior; Subscapularis; Flexor digitorum brevis; Plantar aponeurosis; Flexor digitorum brevis; Flexor digitorum longus; Flexor digiti minimi; Abductor digiti minimi; Quadratus plantae; Flexor digitorum brevis; Flexor hallucis brevis; Abductor halluces; Adductor hallucis; Flexor hallucis brevis; Adductor hallucis; Flexor digitorum; Lumbricals; Flexor digitorum longus tendons; Extensor hallucis brevis|Extensor digitorum brevis; Tibialis anterior; Extensor hallucis longus; Extensor hallucis longus; Extensor digitorum longus; Tibialis anterior; Extensor digitorum longus; Flexor digitorum longus; Tibialis posterior; Tibialis posterior|Flexor hallucis longus; Flexor digitorum longus; Soleus; Flexor hallucis longus; Soleus; Gastrocnemius; Soleus; Popliteus; Gastrocnemius; Distal hamstring; Proximal gastrocnemius; Adductors; Gracilis; Adductors; Hamstrings; Biceps long; short heads; Medial hamstrings; Lateral hamstrings; Rectus femoris; Vastus intermedius; Vastus medialis; Sartorius; Vastus lateralis; Illiotibial band; Adductors; Sartorius; Sartorius; Rectus femoris; Pectineus; Adductors; TFL; Gluteus medius; Gluteus maximus; medius; Quadratus femoris; Inferior gemellus; Superior Gemellus & Piriformis; Gluteus medius & minimus; Quadratus lumborum; Erectors; Multifidus; Erectors; Rotator; Multifidus (Lumbar); Serratus posterior inferior; Latissimus dorsi; Psoas; Iliacus; Semispinalis; Erectors; Rotator; Multifidus (Thoracic); Multifidus; Semispinalis; External oblique; Internal oblique; Rectus capitis minor; Rectus capitis major; Semispinalis capitis; Rectus capitis; Semispinalis capitis; Splenius capitis; Splenius capitis; Trapezius; Scalenes; Omohyoid, or any combinations thereof.

Also, a first aspect and/or a second aspect may include any plurality of such tissues, such as two or more of such tissues.

In some versions, the methods disclosed herein include repeating one or more of the aspects of the methods two or more times. Such repetition may be necessary in order for the methods to be effective, such as to alleviate one or more symptoms and/or treat a condition. For example, in some embodiments, relative motion between a first aspect, e.g., a first tissue, and a second aspect, e.g., a second tissue, is induced a plurality, such as two or more times, such as once in a distance in a first direction and once in a direction in a second direction and/or twice in a distance in the first direction and twice in a direction in the second direction. In some versions, the subject methods may be performed in a plurality of cycles, e.g., 2, 3, 4, 5, 8, 7, 8, 9, 10, 20, or 50 cycles, where a cycle includes moving an aspect, e.g., a tissue, from a first position to a second position and from the second position to the first position. In some embodiments, a portion of a subject's body is moved a plurality of times in a cycle, such as one or more times in a first direction and one or more times in a second direction. Such repetition of the subject methods may include repeating one or more aspects of the methods a number of times, such as 1 to 100 times, such as 1 to 50 times, such as 1 to 20 times, such as 1 to 10 times, such as 3 to 8 times, each range inclusive. In some versions, one or more aspects of the methods are repeated at successive time intervals. Such time intervals may occur 1 second or more, such as 10 seconds or more, such as 1 minute or more, such as 1 hour or more, such as one day or more, such as two days or more, such as one week or more apart. In other words, such time intervals may be one or more, such as two or more, such as seven or more days apart.

Also, in various embodiments, the methods include concluding and/or terminating one or more treatments, such as future treatments. Such termination may be made when, for example, in the judgment of a provider, such as a medical practitioner, and/or the patient, the patient's symptoms have been alleviated sufficiently to justify cessation of treatment. For example, in some instances, treatments are stopped when the patient is experiencing no more symptoms.

### Devices

Aspects of the subject disclosure include devices for performing and/or assisting in one or more aspects of non-surgical human tissue manipulation. Such devices include one or more devices for performing one or more aspects of the methods described above.

Devices according to the subject disclosure include tools for differentiating or facilitating differentiation of a first tissue of the subject and a second tissue of the subject. Such devices may include any of the tools for differentiation described herein. Embodiments of various devices are or include one or more visual aids for a subject and/or a provider, such as one or more forms of media, such as a printed publication, e.g., book, e.g., a printed book or an e-book, an audio presentation, a pamphlet or magazine, one or more photographs, e.g., digital photographs, a slide-show, a video, e.g., a digital video, and/or a computer program for providing media content on a display of an electronic device, e.g., a phone and/or computer, or any combinations thereof. In some versions, the media is digital media. As used herein, the phrase “digital media” is used broadly to refer to digitized content, such as text, graphics, audio files, video files, and combinations thereof, including, e.g., websites, webpages, desktop and mobile device applications, and the like. In some versions, the devices are configured for providing, e.g., displaying, digital media via a social networking service.

The subject devices may include one or more electronic components, such as one or more computers. A computer may include one or more components, such as any of the components described herein, which are operatively coupled to each other, such as physically, electrically and/or communicatively. A computer may include one or more controllers, e.g., a processor, for receiving an input and/or generating an output. For example, a controller may be configured for storing and/or executing instructions presented to it and/or may be operatively coupleable to a power source. A computer may also include one or more display for displaying one or more output. A display may be configured for displaying one or more forms of digital media, such as content on a webpage. An output may be presented by the computer in response to an input of instructions to the computer, such as by operatively coupling an instruction carrying device, e.g., a flash drive, to the controller. The subject devices may also include a graphical user interphase. A computer may also be in remote communication with, e.g., wired or wireless communication with, one or more instruction carrying device, such as one or more cellular telephones. Also, where devices include one or more computers, the computers may each include one or more input device, e.g., a mouse and/or keyboard, and/or controller and/or display, e.g., a presence-sensitive screen, and/or a voice responsive system, and/or a camera, and/or a video recorder, and/or a microphone, and/or a GPS module, or any other type of device for detecting a command from a user or sensing the environment. In some aspects, a presence-sensitive screen includes a touch-sensitive screen. Furthermore, any of such media tools for differentiating may be used for example, prior to, or during differentiation to assist in differentiating one or more aspects, such as tissues.

The various components and/or parties of the present disclosure may communicate over a network including electronic devices connected either physically or wirelessly, wherein digital information is transmitted from one device to another. Such devices (e.g., end-user devices and/or servers) may include, but are not limited to: a desktop computer, a laptop computer, a handheld device or PDA, a cellular telephone, a set top box, an Internet appliance, an Internet TV system, a mobile device or tablet, or systems equivalent thereto. Exemplary networks include a Local Area Network, a Wide Area Network, an organizational intranet, the Internet, or networks equivalent thereto.

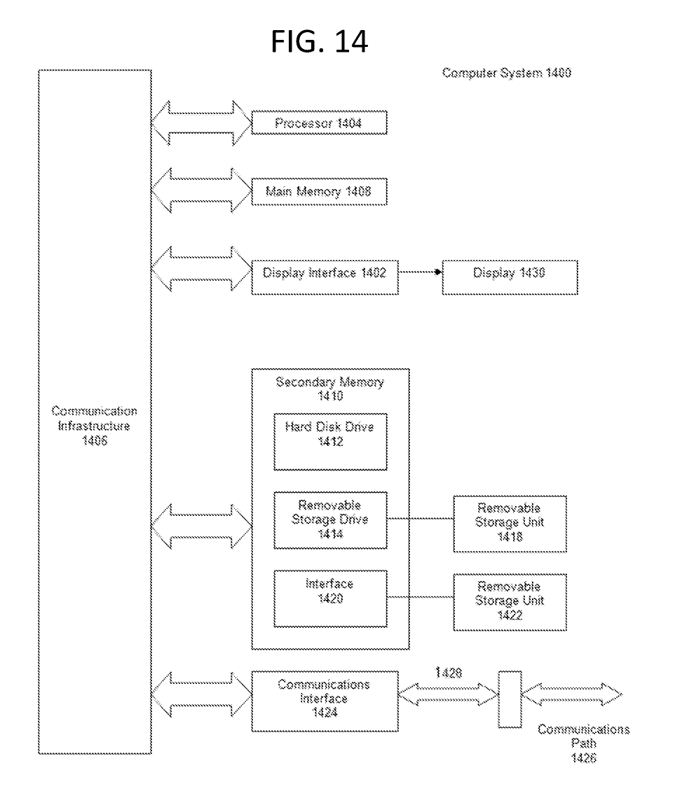

The present disclosure, in various embodiments, is directed toward one or more computer systems capable of carrying out the functionality and/or aspects of the methods described herein. For example, FIG. 14 is a schematic drawing of a computer system 1400 which may be applied to implement the methods presented above. Computer system 1400 includes one or more processors, such as processor 1404. The processor 1404 is connected to a communication infrastructure 1406 (e.g., a communications bus, cross-over bar, or network). Computer system 1400 can include a display interface 1402 that forwards graphics, text, and other data from the communication infrastructure 1406 (or from a frame buffer not shown) for display on a local or remote display unit 1430.

The computer system 1400 depicted schematically in FIG. 14 also includes a main memory 1408, such as random access memory (RAM), and may also include a secondary memory 1410. The secondary memory 1410 may include, for example, a hard disk drive 1412 and/or a removable storage drive 1414, representing a floppy disk drive, a magnetic tape drive, an optical disk drive, flash memory device, etc. The removable storage drive 1414 reads from and/or writes to a removable storage unit 1418. Removable storage unit 1418 represents a floppy disk, magnetic tape, optical disk, flash memory device, etc., which is read by and written to by removable storage drive 1414. As will be appreciated, the removable storage unit 1418 includes a computer usable storage medium having stored therein computer software, instructions, and/or data.

According to some aspects of the subject devices, secondary memory 1410 may include other similar devices for allowing computer programs or other instructions to be loaded into computer system 1400. Such devices may include, for example, a removable storage unit 1422 and an interface 1420. Examples of such may include a program cartridge and cartridge interface (such as that found in video game devices), a removable memory chip (such as an erasable programmable read only memory (EPROM), or programmable read only memory (PROM)) and associated socket, and other removable storage units 1422 and interfaces 1420, which allow computer software, instructions, and/or data to be transferred from the removable storage unit 1422 to computer system 1400.

In some aspects, a communications interface 1424 may be included in computer system 1400. Communications interface 1424 allows computer software, instructions, and/or data to be transferred between computer system 1400 and external devices. Examples of communications interface 1424 may include a modem, a network interface (such as an Ethernet card), a communications port, a Personal Computer Memory Card International Association (PCMCIA) slot and card, etc. Software and data transferred via communications interface 1424 are in the form of signals 1428 which may be electronic, electromagnetic, optical or other signals capable of being received by communications interface 1424. These signals 1428 are provided to communications interface 424 via a communications path (e.g., channel) 1426. This channel 1426 carries signals 1428 and may be implemented using wire or cable, fiber optics, a telephone line, a cellular link, a radio frequency (RF) link, a wireless communication link, and/or other communications channels.

As used herein, the terms “computer program medium,” “computer-readable storage medium,” and “computer usable medium” are used to generally refer to media such as removable storage drive 1414, removable storage units 1418, 1422, data transmitted via communications interface 1424, and/or a hard disk installed in hard disk drive 1412. These computer program products provide computer software, instructions, and/or data to computer system 1400. These computer program products also serve to transform a general purpose computer into a special purpose computer programmed to perform particular functions, pursuant to instructions from the computer program products/software. Embodiments of the subject disclosure are directed to such computer program products.

Various embodiments of computer programs (also referred to as computer control logic) are stored in main memory 1408 and/or secondary memory 1410. Computer programs may also be received via communications interface 1424. Such computer programs, when executed, enable the computer system 1400 to perform the features of the present disclosure, as discussed herein. In particular, the computer programs, when executed, enable the processor 1404 to perform the features of the presented methods. Accordingly, such computer programs represent controllers of the computer system 1400. Where appropriate, the processor 1404, associated components, and equivalent systems and sub-systems thus serve as “means for” performing selected operations and functions. Such “means for” performing selected operations and functions also serve to transform a general purpose computer into a special purpose computer programmed to perform the selected functions and operations.

In embodiments where aspects of the subject disclosure are implemented using software, the software may be stored in a computer program product and loaded into computer system 1400 using removable storage drive 1414, interface 1420, hard drive 1412, communications interface 1424, or equivalents thereof. The control logic (software), when executed by the processor 1404, causes the processor 1404 to perform the methods and functions described herein.

In other versions, the methods are implemented fully or primarily in hardware using, for example, hardware components such as application specific integrated circuits (ASICs). Implementation of the hardware state machine so as to perform the functions and methods described herein will be apparent to persons skilled in the relevant art(s). In yet another embodiment, the methods are implemented using a combination of both software and hardware.

Embodiments of the subject disclosure, including any systems and methods described herein, may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. In some embodiments, machine readable medium is provided in a non-transitory form. Further, firmware, software, routines, and instructions may be described herein as performing certain actions. However, it should be appreciated that such descriptions are merely for convenience and that such actions in fact result from computing devices, processors, controllers, or other devices executing firmware, software, instructions, and/or routines.

Embodiments of a computer system include an operating system, such as a Windows®, Apple® OS, iOS®, or Android® operating system. The operating system controls operations of the components of the computer system. For example, the operating system may facilitate the interaction among processors, memory, network interface, storage device(s), input device, output devices, and/or a power source. The computer systems described herein may also include one or more power sources to provide power to the computer system. Non-limiting examples of power sources include single-use power sources, rechargeable power sources, and/or power sources developed from nickel-cadmium, lithium-ion, or other suitable material, such as batteries.

Output devices may also be included in a computer system of the present disclosure. Output devices are configured to provide output to a user using, for example, tactile, audio, and/or video stimuli. Output devices may include a display screen (part of the presence-sensitive screen), a sound card, a video graphics adapter card, or any other type of device for converting a signal into an appropriate form understandable to humans or machines. Additional examples of output devices include a speaker, a cathode ray tube (CRT) monitor, a liquid crystal display (LCD), or any other type of device that can generate intelligible output to a user. In some embodiments, a device may act as both an input device and an output device.

According to some aspects of the disclosure, there is provided an article of manufacture including: a machine-readable medium having machine-readable instructions stored thereon, the instructions including: instructions for providing a medical professional and/or a patient with information regarding one or more aspects of the methods described herein; instructions for providing the user with a plurality of customization options for the display of one or more aspects of the methods selected by the user for display via the digital medium; instructions for receiving one or more user selections for the customization options; and instructions for displaying via the digital medium the information regarding one or more aspects of the methods selected by the user for display via the digital medium in accordance with the one or more user selections for the customization options.

The subject devices according to some aspects may include and/or provide information, such as pictures and/or text, describing and/or illustrating locations of tissues, such as subcutaneous tissues, with respect to general anatomical features, e.g., a finger, or a tissue thereof, and/or with respect to other tissues. Such devices may also include information, such as pictures and/or text, describing and/or illustrating any of the methods described herein. The devices may also include information including instruction for gathering information tactilely to differentiate between tissues. Such information, for example, includes recommended areas of a subject's body for performing differentiation based on one or more symptoms.

Such information, for example, may also include recommended tactile placement, such as hand placement of a provider on a subject. Recommended tactile placement, such as hand placement, may include recommended placement for performing differentiation and/or recommended placement, such as hand placement, for performing or inducing tissue movement, according to any of the methods described herein. Information provided by media tools may also illustrate one or more steps of movement, such as body and/or tissue movement according to the methods described herein.

One or more of the devices for differentiating may additionally or alternatively be applied in diagnosing a subject, such as diagnosing a subject with one or more conditions and/or tissue ailments. As noted above, diagnosing may include accessing one or more devices, such as media devices, such as a printed publication, e.g., a book, and/or video and/or computer program, which retains and/or exhibits one or more characteristics of symptoms previously exhibited or expressed by other subjects. For example, diagnosing may include referencing a book or computer program showing common characteristics, e.g., locations, of symptoms on or in the body of a subject for a subject having a particular tissue ailment. Such characteristics as displayed by the device, e.g., locations, can then be compared to characteristics of symptoms currently being expressed or exhibited by a subject being diagnosed. Also, media content for display by the subject devices may, in some aspects, include one or more one or more symptom pattern images or charts.

The devices disclosed herein may be configured for use in training one or more providers to treat patients according to the claimed methods. As such, the devices may include one or more display for displaying to a plurality of providers. Such devices may include visual displays, e.g., overhead transparencies, computer displays, and/or audio visual presentations, such as videos, and/or a video and/or slide projector for displaying such presentations. Such visual displays may be configured for showing representations, e.g., pictures, of actual and/or simulated treatments, symptoms, or aspects of either.

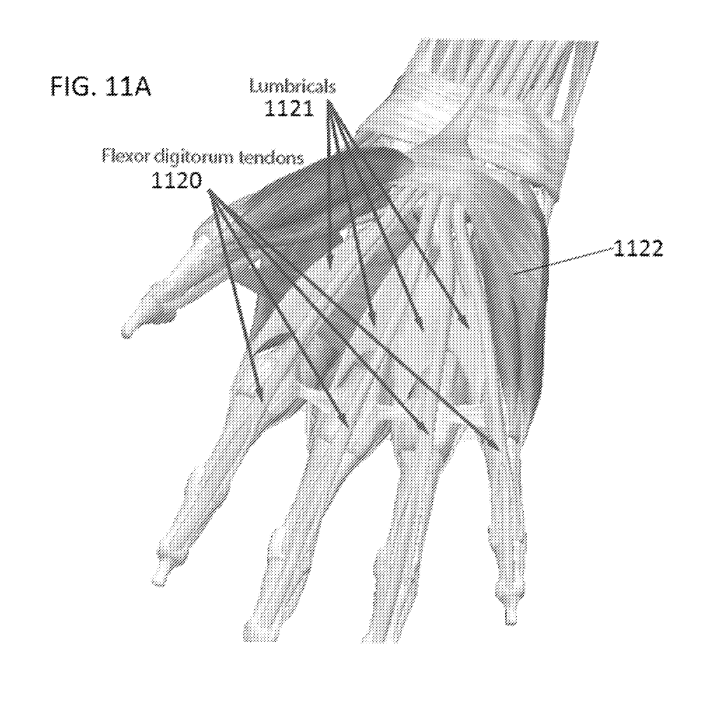

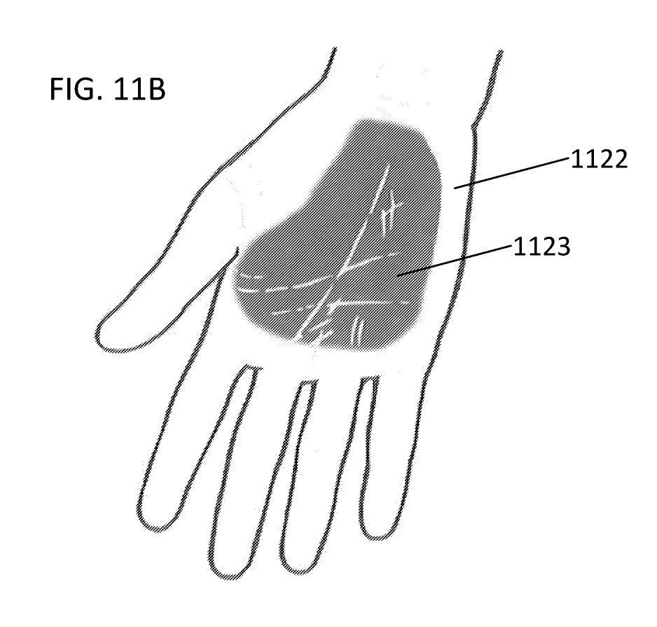

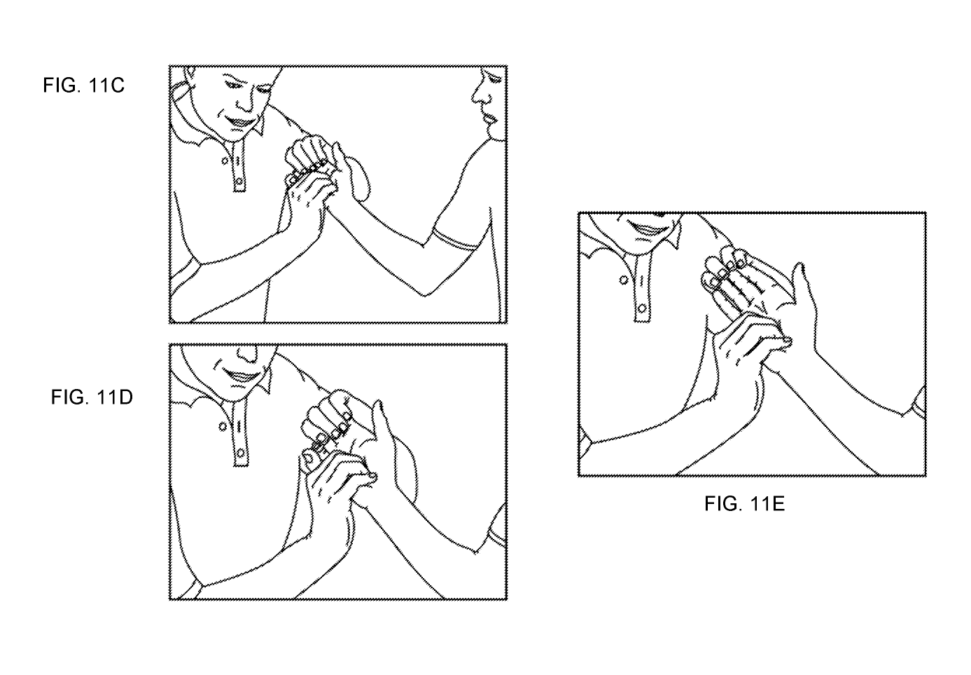

In various embodiments, the subject devices include one or more types and/or sections of media content, such as content which may be presented to a provider and/or subject. Such content may be included in the subject devices, for example, as ink on paper and/or an image and/or video representation on an electronic display. Various types of media content, any one or combination of which may be included in or presented by the subject devices, are illustrated in FIGS. 11A-C.

As is shown in FIG. 11A, in some instances, the devices include an anatomy section of media content, e.g., e.g., a functional anatomy section. An anatomy section may describe and/or depict an anatomical location of one or more aspects, e.g., tissues, proximate to where tissue manipulation may be performed. Such a section may include partial cut-away anatomical drawings which show one or more soft tissues in reference to one or more other body structures, e.g., tissues. An anatomy section may also include one or more tissue identifiers, such as labels of tissues, e.g., the lumbricals 1121 and flexor digitorum tendons 1120, of a hand 1122 which provide an indication of which tissues may be relevant in tissue manipulation.

In some aspects, the devices include a symptom pattern section of media content. Such a section is provided, for example, by FIG. 11B. A symptom pattern section may include one or more symptom pattern images. A symptom pattern image may include a depiction of one or more body portions, e.g., a hand 1122, and one or more symptom pattern areas 1123 thereon. A symptom pattern area may be a portion on the surface of a body at or proximate to a location where one or more symptoms of a subject are occurring. Accordingly, symptom pattern images may be applied for diagnosing a subject and/or determining which method or methods of tissue manipulation should be employed.

Also, as is depicted in FIGS. 11C-11E, the devices may include a treatment section depicting one or more steps and/or descriptions of steps of tissue manipulation. A treatment section may include one or more images depicting, for example, moving a first aspect, e.g., tissue, with respect to a second aspect, e.g., tissue. Such a process may include applying pressure and/or force to a subject. Such a process may also include moving one or more portions of a subject's body. A treatment section may illustrate, for example, the direction and/or magnitude of movement and/or pressure applied during tissue manipulation. Furthermore, in some embodiments, the devices may include a notes section of media content where information on anatomy, and/or tissue manipulation may be recorded and/or retained and/or displayed. One or more additional sections of media content may be included in the subject devices.

The subject devices also include devices for manipulating tissue, such as by contacting and moving tissue. Such devices may be configured for applying pressure and/or exerting force to a first and/or second aspect, such as a first tissue and/or a second tissue, as described above. Such devices may be hand-held and configured for manual operation by a provider. Such devices may also, in various aspects, include one or more protrusions for applying pressure to one or more aspects. Such protrusions may be located on a first end of a device which is opposite a second end. Devices may also include one or more handles, such as handles at a second end of a device.

### Utility

The methods and devices of the subject invention as described above find use in a variety of different applications including applications where alleviation of one or more symptoms are desired. As such, the methods and devices find use in the non-surgical treatment of tissue conditions, such as any of the tissue overuse conditions as described herein and the alleviation, including the complete elimination, of symptoms corresponding therewith.

More specifically, and as described herein, for patients who suffer from one or more tissue conditions, such as tissue overuse conditions, the methods of tissue manipulation described herein may be a favorable alternative to surgery for the treatment thereof. For example, providing tissue manipulation according to the methods described herein may be more time-efficient than a surgical procedure because tissue manipulation may take considerably less time than a surgical procedure and an associated recovery period. Also, by avoiding surgery and the risk associated therewith, a risk to the overall patient's health corresponding with treatment may be reduced. In this manner, the subject methods may also improve the quality of a patient's health and/or the extend duration of the patient's lifespan.

As noted herein, conditions which may be treated using the subject methods may include, but are not limited to, conditions of one or more muscles, tendons, ligaments, fascia, nerves, or any combinations thereof. Also, specific ailment which may be treated include, but are not limited to, carpal tunnel syndrome, shin splints, sciatica, plantar fasciitis, tennis elbow, or any combinations thereof. Corresponding symptoms of such ailments which may be alleviated also include, but are not limited to, back pain, shoulder pain, knee pain, head pain, neck pain, elbow pain, wrist pain, ankle pain, or any combinations thereof. Alleviation of such symptoms may significantly improve the quality of a patient's health and/or improve the ability of the patient to perform physical tasks including exercise.

In addition, the subject devices find use in differentiating one or more aspects, e.g., tissues, such as soft tissues, and/or diagnosing a subject. The devices, and aspects thereof, may also be used in instructing others in providing effective non-surgical treatment methodologies.

### Kits

Also provided are kits that at least include the subject devices and which may be used according to the subject methods. The disclosed kits, in various embodiments, include any of the embodiments of the devices described herein or any combinations thereof. The subject kits may include one or more, e.g., a plurality, e.g., two or more, of the media devices, e.g., printed publications, as described herein. The devices of the subject kits may include media content describing, illustrating and/or relating to one or more embodiments of the methods described herein.

In various aspects, the kits include a display element for displaying one or more aspects of the elements and/or devices described herein. Also, in some variations, kits include a power source for the devices described herein.

In certain embodiments, the kits which are disclosed herein include instructions, such as instructions for using the devices and/or performing the subject methods. The instructions are generally recorded on a suitable recording medium. For example, the instructions may be printed on a substrate, such as paper or plastic, etc. As such, the instructions may be present in the kits as a package insert, in the labeling of the container of the kit or components thereof (i.e., associated with the packaging or subpackaging etc.). In other embodiments, the instructions are present as an electronic storage data file present on a suitable computer readable storage medium, e.g., Portable Flash drive, CD-ROM, diskette, etc. The instructions may take any form, including complete instructions for how to apply the methods and/or devices or as a website address with which instructions posted on the world wide web may be accessed.

In addition, embodiments of the disclosed kits or their components may be used according to any of the embodiments of the methods described herein or combinations thereof.

The following example is offered by way of illustration and not by way of limitation.

### EXAMPLES

The following examples are put forth so as to provide those of ordinary skill in the art with a complete disclosure and description of how to make and use the present invention, and are not intended to limit the scope of the subject disclosure. Nor are the following examples intended to represent that the examples below are all or the only examples performed.

### I. Example 1

A patient was assessed for symptoms including pain in the palm of the patient's hand. After conducting a study of the patent's symptoms by conducting various procedures including palpating the subject's hand and verbally questioning the patient, an appropriate tissue manipulation method was selected.

More specifically, the symptoms were found to exist within the symptom pattern area 1103 as illustrated, for example in FIG. 11B. The symptom pattern image depicted in FIG. 11B was in turn used in helping to select the tissue manipulation method of which several steps are shown in FIGS. 11C-11E.

Upon selecting the depicted method, a preliminary study of anatomy of the hand was conducted by an examination of the partial cut-away anatomical representation of a hand as shown in FIG. 11A. The partial cut-away anatomical representation helped to identify the appropriate tissues, such as soft tissues, for performing the appropriate tissue manipulation method.

In administering the tissue manipulation method, the patient was first retained in an initial tissue manipulation position as shown in FIG. 11C. The initial tissue manipulation position was a seated position wherein the patent's hand was extended from the body while the arm was bent at the elbow. The thumb extended upward while other fingers were partially flexed in a bent position toward the palm. The patient was asked to retain the patient's hand in the initial tissue manipulation position. The hand was then palpated to differentiate a first tissue and a second tissue. In this method, and as shown in FIG. 11A, the first tissue was the lumbricals and the second tissue was the flexor digitorum tendons.

Pressure was then tactilely applied to the lumbricals by applying force in an inward direction to the palm of the patient's hand. In other words, a proximal tension was taken on a lumbrical between the flexor tendons. At the same time, light tactile contact was also made with the ends of the patient's fingers, excluding the thumb.

While pressure was retained on the lumbricals, fingers of the patient were tactilely extended by the provider. In this step, which is shown in FIG. 11C2, the fingers were partially extended at the metacarpal-phalangeal joints only. While still retaining applied pressure and/or proximal tension, the interphalangeal joints were then extended. This step is shown, for example, in FIG. 11C3. Such extension was continued until the fingers of the patient were fully extended.

By taking these steps, the flexor tendons were drawn distally while the lumbricals were held proximally. The process was repeated until an alleviation of symptoms was experienced by the patient. As described herein, repetition of such a process may occur in one session or in multiple sessions of tissue manipulation.

### II. Example 2

A patient was evaluated for symptoms including pain in a portion of patient's leg above the patient's knee. After conducting an assessment of the patent's symptoms by conducting various procedures including palpating the subject's leg and verbally questioning the patient, a tissue manipulation method was selected.

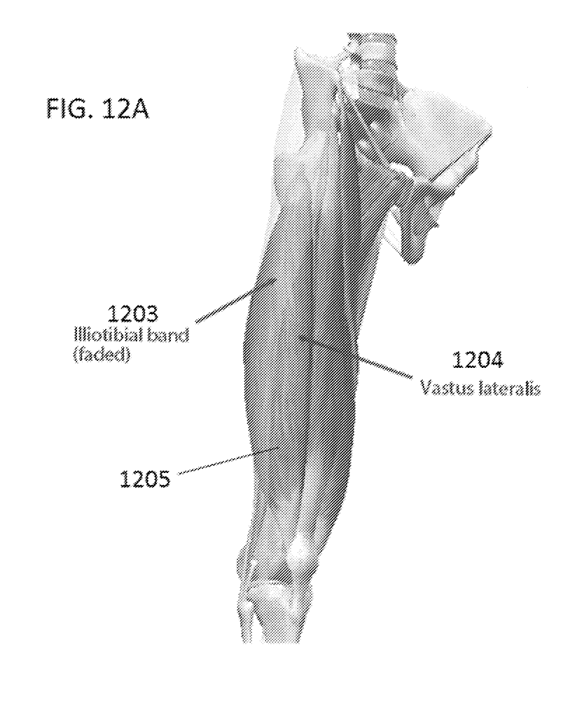

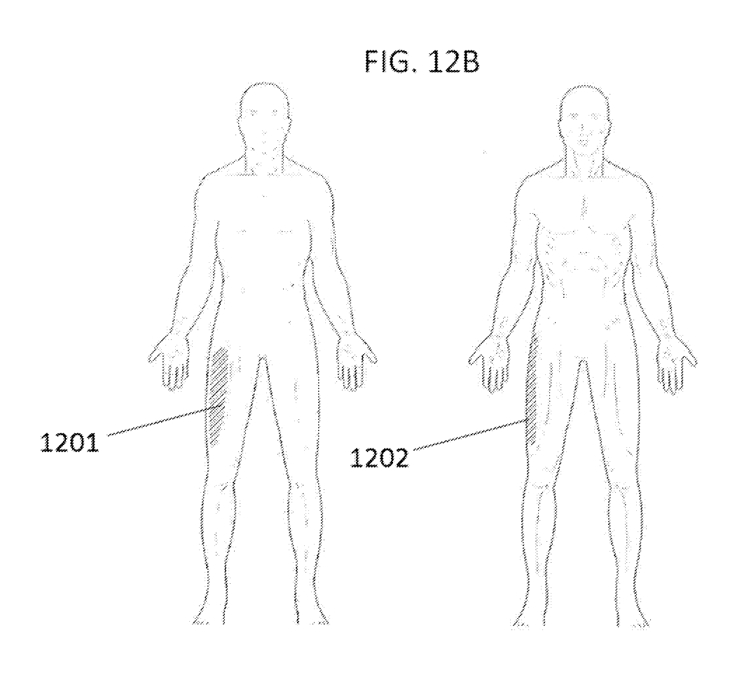

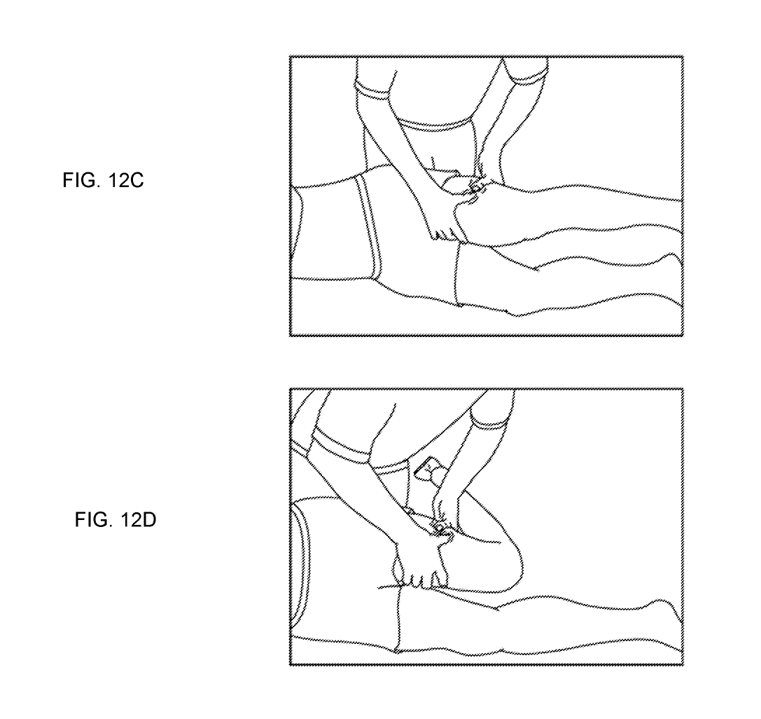

The symptoms were found to exist proximate the symptom pattern areas 1201 and 1202 as illustrated, for example in FIG. 12B. Media including the symptom pattern image depicted in FIG. 12B was in turn used in helping to select the tissue manipulation method as shown in FIG. 12C and FIG. 12D.

After selecting the depicted method, a preliminary study of anatomy of the leg was conducted by an examination of the partial cut-away anatomical representation of a portion of a leg as shown in FIG. 12A. The partial cut-away anatomical representation helped to identify the appropriate tissues, such as subcutaneous soft tissues, for performing the appropriate tissue manipulation method.

To perform the tissue manipulation method, the patient was first retained in an initial tissue manipulation position as shown in FIG. 12C. The initial tissue manipulation position was a lying position wherein the patent lay on their side with one leg slightly raised an apart from the other. The hip of the patient on the side of the raised leg was in abduction. The raised leg was fully or nearly fully extended at the knee. The patient was asked to retain the patient's raised leg in the initial tissue manipulation position. A portion of the raised leg above the patent's knee was then palpated to differentiate a first tissue and a second tissue. In this case, and as illustrated in FIG. 12A, the first tissue was the illiotibial band 1203 and the second tissue was the vastus lateralis 1204 of a human leg 1205. Pressure was then tactilely applied at independent areas to each of the illiotibial band and the vastus lateralis. More specifically, a proximal tension was taken on the illiotibial band and a distal tension was taken on the vastus lateralis.

While pressure was retained on the illiotibial band and the vastus lateralis, the patient was instructed to flex their knee to bend their leg at the knee. Such a flexing step is shown, for example, in FIG. 12D. At the same time, the provider adducted the previously abducted hip and moved the upper portion of the leg in the direction of the patent's ankle of the flexed leg. Taking this action moved the patent's flexing knee downward and in a direction toward the patient's dorsal side. Such action was continued until the position shown in FIG. 12D was reached.

In performing the described steps, the illiotibial band was moved proximally while the vastus lateralis was moved distally. The process was repeated until an alleviation of symptoms was experienced by the patient.

### III. Example 3

A patient was examined for symptoms including pain in the patient's neck. After conducting a study of the patent's symptoms by conducting various procedures including palpating the subject's neck and verbally questioning the patient, an appropriate tissue manipulation method was selected.

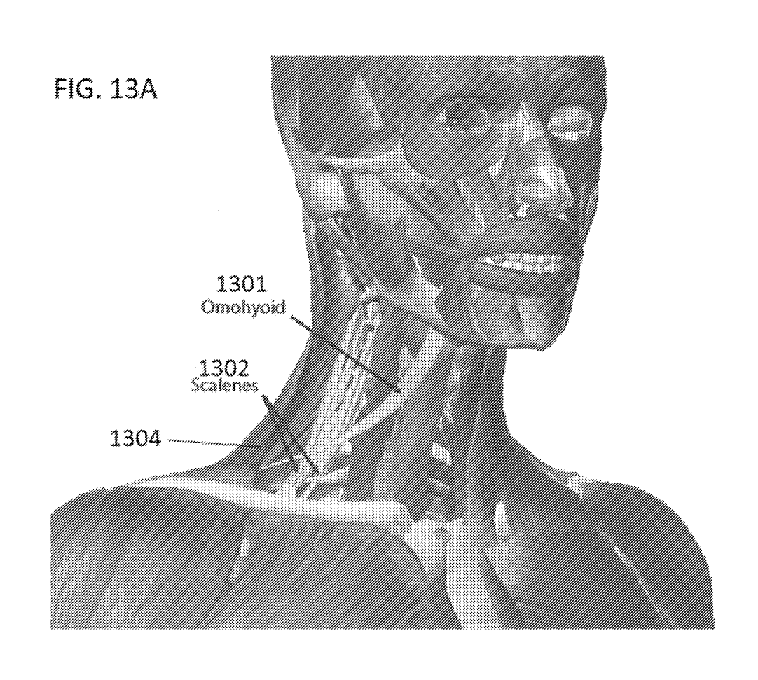

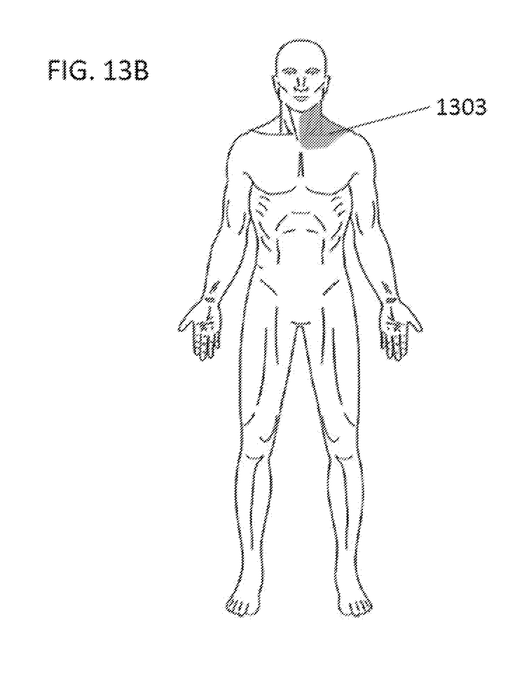

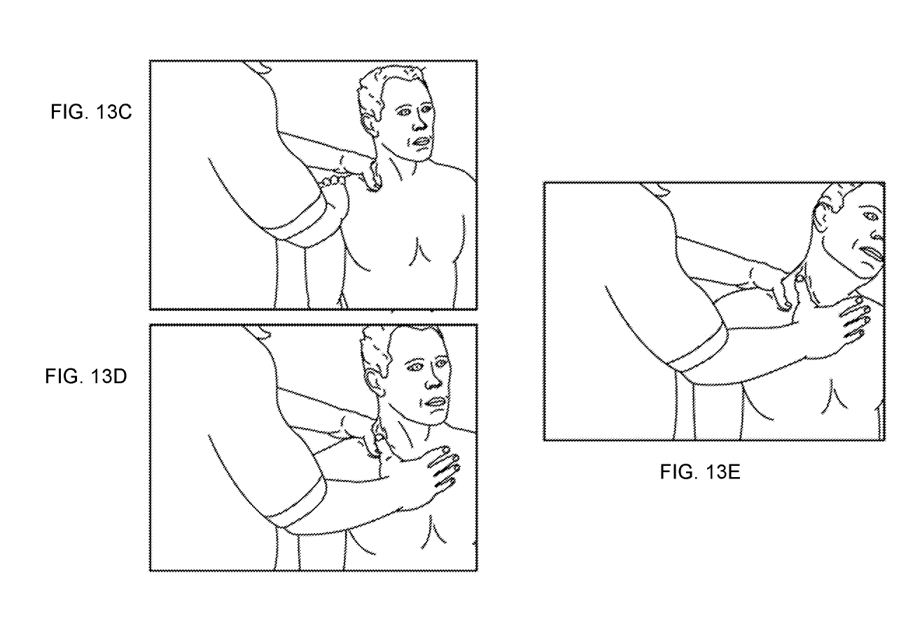

The symptoms were determined to exist proximal the symptom pattern area 1303 as illustrated, for example in FIG. 13B. The symptom pattern image depicted in FIG. 13B was in turn used in helping to select the tissue manipulation method of which several steps are shown in FIG. 13C to FIGS. 13D-13E. In this instance, a printed publication including the representation of an upper torso, neck and head as shown in FIG. 13A, the symptom pattern image shown in FIG. 13B and the images depicting steps of FIG. 13C to FIGS. 13D-13E was used in the various described steps of diagnosis and tissue manipulation.

After selecting the appropriate method, an initial assessment of anatomy of the neck was conducted by an examination of the partial cut-away anatomical representation of an upper torso, neck and head as shown in FIG. 13A. The partial cut-away anatomical representation helped to identify the appropriate tissues, such as soft tissues, for performing the appropriate tissue manipulation method.

In performing the tissue appropriate manipulation method, the patient was retained in an initial tissue manipulation position as shown in FIG. 13C. The initial tissue manipulation position was a seated position with the patient's arms contacting the side of the patient's torso. A shoulder of the patient was then retracted as shown in FIG. 13C. The patient was asked to retain the patient's body, in the initial tissue manipulation position.

The patient's neck was then palpated to differentiate a first tissue and a second tissue. In this method, and as shown in FIG. 13A, the first tissue was the omohyoid 1301 and the second tissue was the scalenes 1302 of a human neck 1304. As shown, for example, in FIG. 13D, pressure was then tactilely applied to the omohyoid and to the scalenes. More specifically, an anterior tension was first applied on the omohyoid and then an inferior tension was applied on the omohyoid while a superior tension was taken on the scalenes. In other words, pressure was first applied to the omohyoid in a first direction, e.g., in the direction of an anterior tension, and subsequently in a second direction, e.g., in the direction of an inferior tension. A pressure in a direction, e.g., in the direction of a superior tension, was also simultaneously applied on the scalenes.

While pressure was retained on the omohyoid and the scalenes, the patient was asked to move the patient's head by laterally flexing the patient's cervical spine away from the side of the patient to which pressure was applied. Such a flexed position is depicted, for example, in FIG. 13E. By taking these steps, the scalenes moved superiorly while the omohyoid was held in place. The process was repeated until the patient experienced an alleviation of the patient's symptoms.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims. It is also to be understood that the terminology used herein is for the purpose of describing particular embodiments only, and is not intended to be limiting, since the scope of the present invention will be limited only by the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by any inventor(s) to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A method of non-surgical human tissue manipulation, the method comprising:
differentiating a first tissue of the subject and a second tissue of the subject, wherein the first tissue and the second tissue are each a subcutaneous tissue; and
inducing relative motion between the first tissue and the second tissue, wherein inducing the relative motion comprises restricting motion of the first tissue and causing the second tissue to move with respect to the first tissue.

2. The method according to claim 1, wherein restricting motion of the first tissue comprises applying pressure to the first tissue.

3. The method according to claim 2, wherein the pressure is applied to the first tissue via a first contact area.

4. The method according to claim 2, wherein the pressure is applied to the first tissue tactilely.

5. The method according to claim 3, wherein inducing relative motion between the first tissue and the second tissue further comprises applying pressure to the second tissue via a second contact area to thereby move the second tissue with respect to the first tissue.

6. The method according to claim 1, wherein restricting motion of the first tissue comprises maintaining at least a portion of the subject's body in a position.

7. The method according to claim 1, wherein causing the second tissue to move with respect to the first tissue comprises inducing movement of at least a portion of the subject's body while the motion of the first tissue is restricted.

8. The method according to claim 7, wherein inducing movement of at least a portion of the subject's body comprises exerting an external force thereon.

9. The method according to claim 7, wherein inducing movement of at least a portion of the subject's body comprises instructing the subject to move the portion of the subject's body.

10. The method according to claim 7, wherein the portion of the subject's body is operatively connected to the second tissue.

11. The method according to claim 7, wherein the portion of the subject's body comprises an appendage of the subject.

12. The method according to any one of claim 1, further comprising treating the subject for a tissue ailment, wherein the ailment includes a muscle overuse condition.

13. The method according to claim 12, wherein the ailments are conditions of one or more muscles, tendons, ligaments, fascia, or nerves.

14. The method according to claim 12, wherein the ailments comprise carpal tunnel syndrome, shin splints, sciatica, plantar fasciitis, tennis elbow, or any combinations thereof.

15. The method according to claim 12, wherein the method comprises alleviating one or more symptoms of the tissue ailment.

16. The method according to claim 12, wherein symptoms of the ailment include back pain, shoulder pain, knee pain, head pain, neck pain, elbow pain, wrist pain, ankle pain, or any combinations thereof.

17. The method according to claim 1, wherein the method further comprises diagnosing one or more tissue ailments in a subject by assessing functional movement of one or more portions of the subject's body.

18. The method according to claim 1, wherein inducing relative motion between the first tissue and the second tissue increases freedom of movement between the first tissue and the second tissue.

19. The method according to claim 1, further comprising arranging at least a portion of the subject's body in an initial tissue manipulation position.

20. A method of non-surgical human tissue manipulation, the method comprising:
differentiating a first tissue of the subject and a second tissue of the subject, wherein the first tissue and the second tissue are each a subcutaneous tissue; and
inducing relative motion between the first tissue and the second tissue, wherein inducing relative motion between the first tissue and the second tissue comprises moving the first tissue a first distance by applying pressure to the first tissue via a first contact area and moving the second tissue a second distance, and wherein inducing relative motion between the first tissue and the second tissue comprises increasing freedom of movement between the first tissue and the second tissue.

21. The method according to claim 20, wherein moving the second tissue a second distance comprises applying pressure to the second tissue via a second contact area to thereby move the second tissue with respect to the first tissue.

22. The method according to claim 20, wherein moving the first tissue a first distance and moving the second tissue a second distance comprises inducing movement of at least a portion of the subject's body while pressure is applied to the first tissue.

23. A method of non-surgical human tissue manipulation, the method comprising:
differentiating a first tissue of the subject and a second tissue of the subject, wherein the first tissue and the second tissue are each a subcutaneous tissue; and
inducing relative motion between the first tissue and the second tissue, wherein inducing relative motion between the first tissue and the second tissue comprises applying pressure to the first tissue via a first contact area and applying pressure to the second tissue via a second contact area while moving the first tissue a first distance by inducing movement of at least a first portion of the subject's body which is operatively connected to the first tissue, and moving the second tissue a second distance by inducing movement of at least a second portion of the subject's body which is operatively connected to the second tissue.

24. The method according to claim 23, wherein inducing movement of at least the first portion of the subject's body comprises exerting an external force thereon.

25. The method according to claim 23, wherein inducing movement of at least the first portion of the subject's body comprises instructing the subject to move the first portion of the subject's body.

26. A method of tissue adjustment, the method comprising:
applying pressure to a first tissue to substantially prevent movement of the first tissue; and
inducing movement of at least a portion of a body of a subject;
wherein inducing movement of at least a portion of a body of a subject comprises:
inducing movement of a second tissue with respect the first tissue, wherein the first tissue and the second tissue are each a subcutaneous tissue, and wherein the first tissue is adjacent to the second tissue within the body of the subject; and
exerting an external force on the portion of the body of the subject or instructing the subject to move the portion of the body of the subject.

27. The method according to claim 26, wherein inducing movement of a second tissue with respect the first tissue comprises causing the second tissue to slide along the first tissue.

28. The method according to claim 26, wherein the method further comprises alleviating one or more symptoms of one or more overuse conditions.

29. The method according to claim 28, further comprising diagnosing the subject with the one or more overuse conditions.

30. The method according to claim 29, wherein the pressure is applied to the first tissue via a first contact area and a location of the first contact area is determined based on the diagnosis of the one or more overuse conditions.
